(19) United States
(12) Patent Application Publication
(10) Pub. No.: US 2025/0131346 A1
(43) Pub. Date: Apr. 24, 2025

(54) Optimizing Environmental Lifetime of an Object

(71) Applicant: Woods Hole Oceanographic Institution, Woods Hole, MA (US)

(72) Inventors: Bryan D. JAMES, Boston, MA (US); Collin P. WARD, Plymouth, MA (US)

(21) Appl. No.: 18/916,849

(22) Filed: Oct. 16, 2024

Related U.S. Application Data
(60) Provisional application No. 63/544,829, filed on Oct. 19, 2023.

(51) Int. Cl. G06Q 10/04; G06Q 10/10

(52) U.S. Cl. CPC G06Q 10/04; G06Q 10/10

(57) ABSTRACT

A system and method to optimize eco-design, including composition and/or geometry, of objects with low environmental persistence and uncompromised performance by obtaining and integrating the environmental degradation rate of assigned materials. An environmental lifetime is determined for the object based on (a) geometry of the object, (b) the assigned material, (c) density, and (d) specific surface degradation rate. A report is generated detailing performance of the geometry for the object using the assigned material with respect to at least the cost and environmental lifetime information.

### CROSS-REFERENCE TO RELATED APPLICATION

This application claims priority to U.S. Provisional Patent Application No. 63/544,829 filed Oct. 19, 2023. The entire contents of the above-mentioned application are incorporated herein by reference as if set forth herein in entirety.

### STATEMENT REGARDING GOVERNMENT SUPPORT

The present invention was made with Government support under grant CAS-MNP-2202621 awarded by the U.S. National Science Foundation. The Government has certain rights in the invention.

### FIELD OF THE INVENTION

This invention relates to systems, techniques and metrics for selecting materials and/or geometries in product design that minimize pollution in the environment.

### BACKGROUND OF THE INVENTION

Sustainability and the circular economy have become cornerstones of corporate strategy. Today's products must satisfy the needs of engineering, marketing, business, regulation, and consumer preference while also being sustainable. Design decisions rely on eco-design and green chemistry principles, life cycle assessments (LCA), and related methods to reduce a product's environmental impact. Materials are selected principally by balancing trade-offs between environmental impact categories, such as greenhouse gas (GHG) emissions and water usage during production. However, environmental persistence, defined as the time an object such as a polymeric “plastic” item lasts in the environment as pollution and also referred to herein as “environmental lifetime”, is missing from the selection criteria.

Plastics, as one example of common human-engineered materials, do break down in the environment, but estimates of the environmental lifetime of plastic products have only recently been made. These estimates vary widely and range from months to decades or longer. Biotic and abiotic processes act to fragment, degrade, transform, modify, assimilate, and mineralize plastics in natural and engineered environments. The efficiency and selectivity of these processes depend on environmental conditions, the type of plastic, and the functionality and geometry of the product (i.e., on features of product design). Thus, an opportunity exists to consider environmental breakdown in the design of various objects including plastic products. Because some plastic products will inevitably enter the environment as pollution, regardless of waste management strategies, it is necessary to confront their persistence. See, e.g., Mazzotta, M. G., Reddy, C. M. & Ward, C. P., Rapid Degradation of Cellulose Diacetate by Marine Microbes, Environ. Sci. Technol. Lett. 9, 37-41 (2022) (“Mazzotta et al.”).

With the understanding that more persistent materials pose greater potential threats to ecosystems and human health, environmental persistence is a fundamental principle of regulatory frameworks. Therefore, considering persistence during product design by selecting materials that quickly break down when leaked into the environment presents an opportunity to minimize risks to ecosystems and human health.

It is therefore desirable to augment material selection practices, formulating a novel eco-design framework for minimizing the persistence of objects in the environment.

### SUMMARY OF THE INVENTION

An object of the present invention is to optimize design parameters for an object to decrease its environmental lifetime.

Another object of the present invention is to evaluate changes in composition and/or geometry of the object to decrease environmental persistence without compromising performance.

This invention features a system to optimize composition and/or geometry of an object to decrease its environmental lifetime, including a database module having specific surface degradation rate information in a non-transitory storage medium, and an environmental lifetime module that (1) receives geometry information and material property information for the object including an assigned material, a density, and a specific surface degradation rate for that material and (2) determines an environmental lifetime for the object based on (a) the geometry of the object, (b) the assigned material, (c) the density, and (d) specific surface degradation rate. The system further includes a design objectives trade-off module that (1) receives geometry and environmental lifetime for the object plus at least density and material price information for the assigned material and (2) generates a report detailing performance of the geometry for the object using the assigned material with respect to at least the cost and environmental lifetime information to enable optimization of at least one of cost and/or environmental lifetime for the object.

In one embodiment, the report includes a design recommendation to optimize at least one of cost and/or environmental lifetime for the object and, in some embodiments, a human-viewable plot of values. In certain embodiments, the report is provided to an output device such as a display or a printer to enable the report to be viewed by a user of the system. In some embodiments, the database module determines a specific surface degradation rate (k_{d}) for at least one material. In certain embodiments, the geometry information received by the environmental lifetime module includes at least volume and surface area of the object, and the environmental lifetime is determined based also on the mass of the object.

This invention also features a system including at least one computer processor, at least one database module operatively connected to the processor and including specific surface degradation rate information in a non-transitory storage medium, and at least one computer-readable, non-transitory instruction medium operatively connected to the processor and having stored thereon instructions that when executed by the processor cause the processor to optimize selection of material for and/or geometry of an object with decreased environmental lifetime. In a number of embodiments, the instructions include:
(1) obtaining and storing a geometry, a density and specific surface degradation rate information in the non-transitory storage medium for each object and its assigned material;
(2) receiving assigned geometry information and assigned material property information for the object including an assigned material, an assigned density and a specific surface degradation rate for that assigned material;
(3) determining an environmental lifetime for the object based on (a) the assigned geometry of the object, (b) the assigned material, (c) the assigned density, and (d) the specific surface degradation rate;
(4) iteratively repeating at least steps (2) to (3) with at least one changed assigned value until environmental lifetime converges to a value less than or equal to a pre-selected convergence criteria;
(5) receiving assigned geometry and environmental lifetime for the object plus at least assigned density and material price information for the assigned material; and
(6) generating a report detailing performance of the geometry for the object using the assigned material with respect to at least the cost and environmental lifetime information.

This invention further features a method to optimize selection of material for and/or geometry of an object with decreased environmental lifetime, including obtaining and storing a geometry, a density, and specific surface degradation rate information in a computer-readable non-transitory storage medium for each object and its assigned material, receiving assigned geometry information and assigned material property information for the object including an assigned material, an assigned density, and a specific surface degradation rate for that material, and determining an environmental lifetime for the object based on (a) the geometry of the object, (b) the assigned material, (c) the density, and (d) the specific surface degradation rate. The method further includes receiving geometry and environmental lifetime for the object plus at least density and material price information for the assigned material, generating a report detailing performance of the geometry for the object using the assigned material with respect to at least the cost and environmental lifetime information, and optimizing at least one of cost and/or environmental lifetime for the object.

In a number of embodiments, optimizing includes iteratively repeating the step of determining an environmental lifetime with at least one changed assigned value until environmental lifetime converges to value less than or equal to a pre-selected convergence criteria. In some embodiments, generating the report includes producing a human-viewable plot of values on a GUI (Graphical User Interface) device or other human-machine interface including computer monitors and other output devices. In certain embodiments, the object is made of a polymeric material. In some embodiments, the method further includes determining a specific surface degradation rate (k_{d}) for at least one assigned material and/or determining degradation of test samples of the object over time. In one embodiment, optimizing includes evaluating performance of the object for at least one of mechanical, thermal, electrical, magnetic, flow, and/or processing performance.

### BRIEF DESCRIPTION OF THE DRAWINGS

To enable a better understanding of the present invention, and to show how the same may be carried into effect, certain embodiments of the invention are explained in more detail with reference to the drawings, by way of example only, in which:

FIG. 1A a schematic side view of a simply supported beam to be deflected to design a stiff beam with minimal environmental lifetime at end-of use according to the present invention;

FIG. 1B is a chart schematically illustrating certain parameters for environmental lifetime estimation and material selection according to the present invention;

FIG. 1C is a chart of trade-off factors;

FIG. 2A is a schematic spider plot comparing material indices (MIs) for mass, cost, embodied greenhouse gas (GHG) emissions, water usage, and environmental lifetime of current and potential alternative plastics;

FIG. 2B is a chart comparing cost of material;

FIG. 2C is a chart of estimated social cost of CO₂ for certain products;

FIG. 2D is a chart of estimated cost of plastic pollution for certain products;

FIG. 3 is another spider plot comparing current and potential materials for making food trays and takeaway containers relative to polystyrene (PS) foam for various performance, lifetime and environmental impact categories;

FIG. 4 is another spider plot similar to FIG. 3 comparing materials in foam and solid forms;

FIG. 5A is a schematic block diagram of a system according to the present invention;

FIG. 5B is a schematic flow diagram showing an optimization process according to the present invention;

FIG. 6 is a schematic flowchart of preparing a new plastic material including determining its specific surface degradation rate (k_{d});

FIG. 7 is a schematic flowchart of evaluating degradation of samples over time;

FIGS. 8A-8D are schematic diagrams of analyzing solid samples;

FIGS. 9A-9G are schematic cross-sectional diagrams of analyzing samples having one or more internal voids;

FIG. 10A is a chart showing a comparison of the marine environment-specific surface degradation rate (k_{d}) of different materials listed along the x-axis;

FIG. 10B is a chart showing the relationship between the relative specific surface degradation rate of cellulose diacetate foams (k_{d}^{foam}/k_{d}^{solid}) and the relative density of the foams (p_{foam}/p_{solid}); and

FIGS. 11A-11C are material property charts comparing properties density (ρ) and Young's modulus (E) in FIG. 11A, specific surface degradation rate (kd) and E in FIG. 11B, and ρ and k_{d}E^{2/3} in FIG. 11C.

### DETAILED DESCRIPTION OF THE PRESENTLY PREFERRED EMBODIMENTS

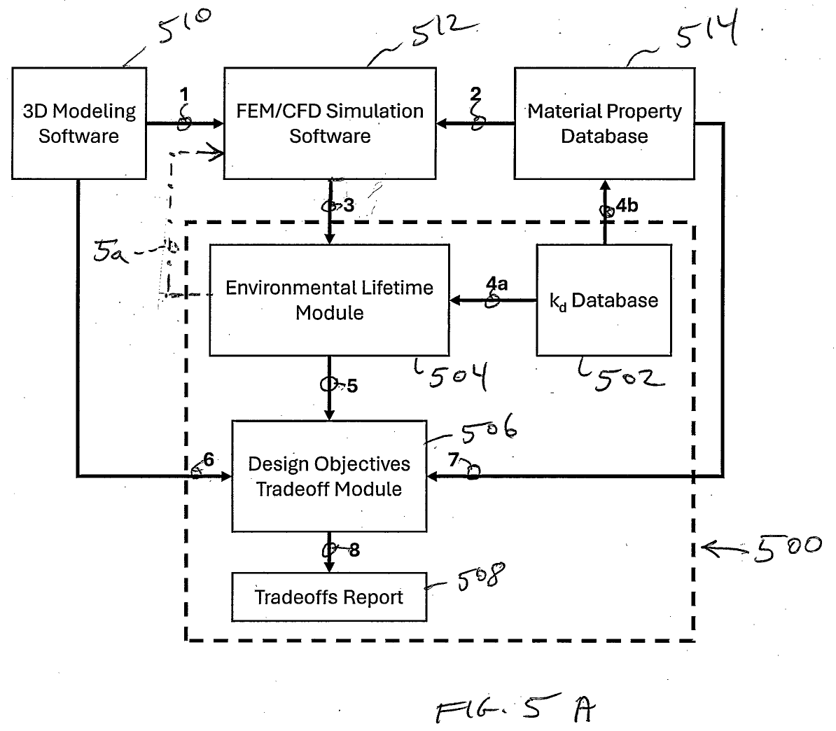

This invention may be accomplished by a system as illustrated in FIGS. 5A-5B, for example, and methods as described herein. Materials to be analyzed according to the present invention include any material that can experience surface erosion, such as polymers, metals and alloys thereof, ceramics and composites. Geometries of objects to be analyzed include coatings, particles, fibers, fabrics (woven and/or non-woven), foams and solids. Any environment, whether man-made or naturally occurring, can be analyzed including soil, sediment, landfill, compost (home or industrial), sewage and other wastewater, drinking water, freshwater, seawater and other liquids, as well as indoor and outdoor atmosphere and other gases, an organism's body, an anaerobic digester, and reactors (bio- and/or photo-).

Abbreviations utilized herein include MIs (material indices), PET (polyethylene terephthalate), PA (polyamide), PHA (polyhydroxyalkanoate) PLA (polylactic acid), PS (polystyrene), PCL (polycaprolactone), PC (polycarbonate), PBS (polybutylene succinate), PBAT (polybutylene adipate terephthalate), PP (polypropylene), LDPE (low-density polyethylene), HDPE (high-density polyethylene), CDA (cellulose diacetate), and PUR (polyurethane).

Selecting appropriate materials is critical for engineers, industrial designers, and architects to create functional and aesthetically pleasing products. The problem of choosing the “best” material can be framed as a collection of design requirements (i.e., functions, objectives, and constraints) for which material indices (MIs) can be determined and optimized. MIs are material properties or groups of properties that maximize performance for a given objective (e.g., minimizing mass, cost, or an environmental impact).

Missing from conventional material selection is an MI for environmental persistence, also referred to herein as environmental lifetime, i.e., a metric for optimizing the environmental lifetime of an item after its release to the environment as pollution. Degradation rates are material properties and thus can be included as an integral part of product design. While definitions for degradation can vary, herein, we limit the definition of degradation to overall mass loss from the initial plastic item in marine environments.

Complementary to this, we define environmental lifetime as the time it takes for an item's mass to reduce to zero because of degradative processes. Accordingly, systems and methods according to the present invention optimize persistence in material selection by analyzing criteria to minimize environmental lifetime at end-of-use. Much like other MIs (Section 1 and Table S1 in Supplemental Information below), we developed an approach to derive MIs for environmental lifetime by i) defining the appropriate objective equation and ii) substituting relationships for the initial geometry of the item specified by the design constraints.

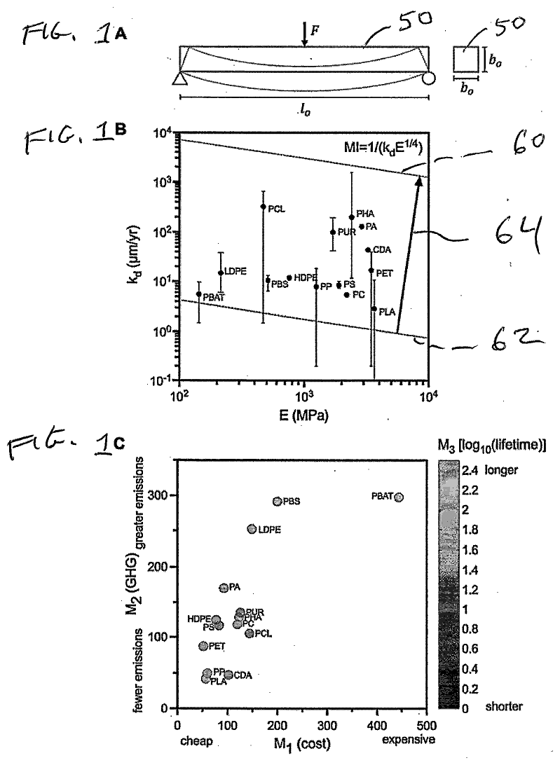

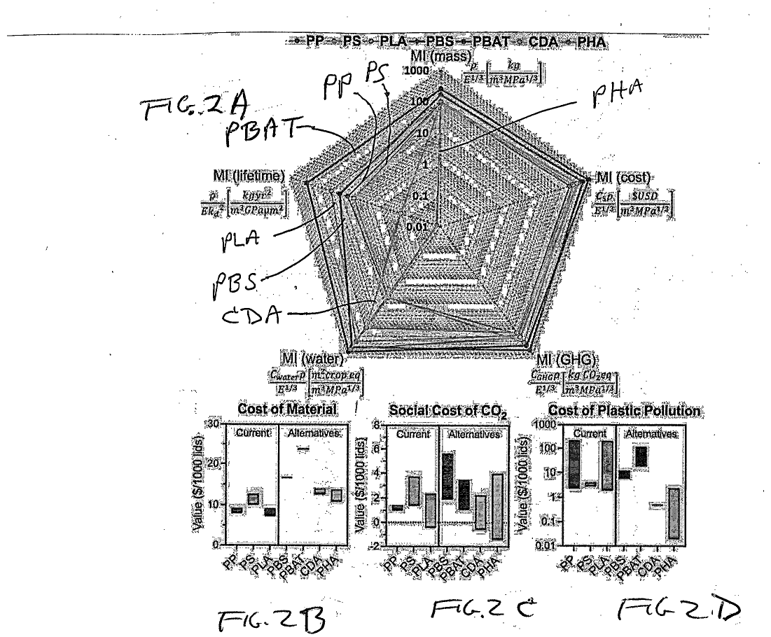

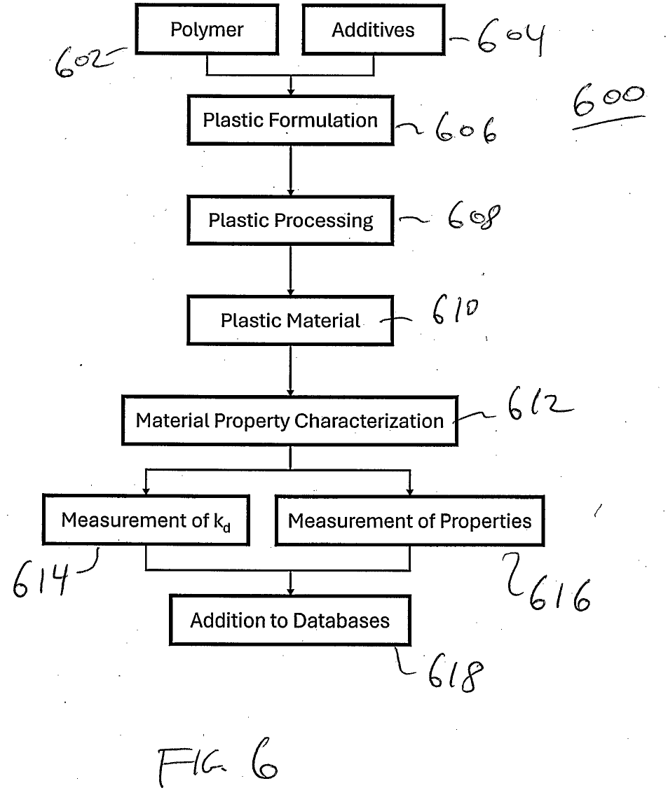

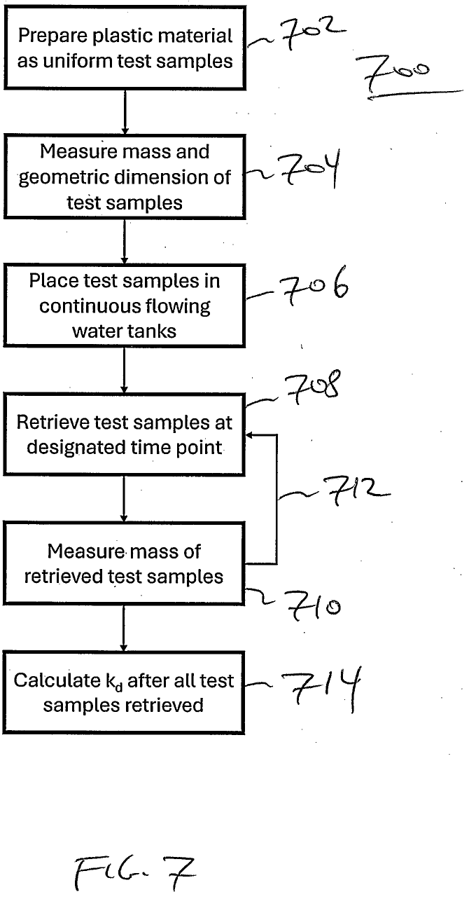

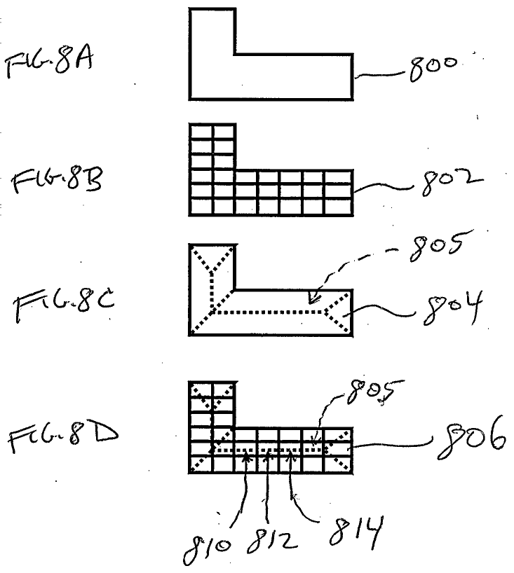

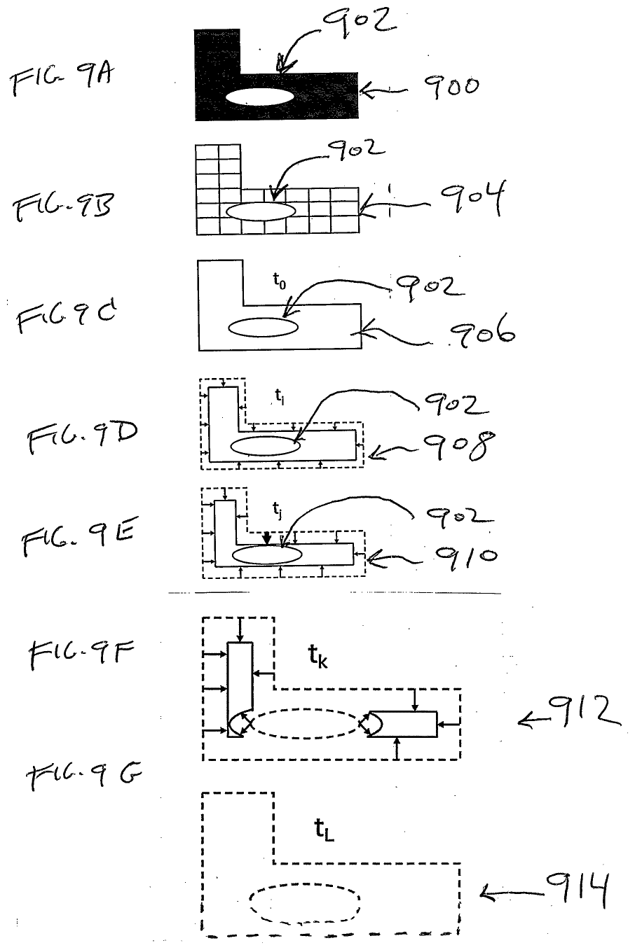

To demonstrate the approach, consider the design of a stiff beam 50 as illustrated in FIG. 1A; more complex geometries are discussed below in relation to FIGS. 8A-9G. A typical function for a beam is to support a load without sagging. Rather than minimize the beam's mass or cost, the design objective for persistence is to minimize the beam's environmental lifetime at end-of-use. The design constraints on the beam define the loading conditions, amount of tolerable deflection, and geometry. The free, unconstrained variables are the choice of material and some geometric features. To derive an MI for persistence, we first defined the objective equation by solving a degradation rate equation, establishing a mathematical relationship between environmental lifetime and the geometry of the beam.

The uniform degradation rate of a plastic item in the environment can be defined as the differential mass loss per unit time (dm/dt), equal to the product of the surface area (Aₛ) of the item and the density (ρ) and specific surface degradation rate (k_{d}) of the item's material (Equation 1):

$$\frac{dm}{dt} = - ρ {k}_{d} {A}_{s} \qquad Eq . 1$$

In this formulation, k_{d} is a phenomenological parameter that assumes all mass loss is by surface erosion. Notably, this framing implies that intrinsic properties of the material and extrinsic properties of the item (e.g., shape, size) control the item's degradation rate. Additionally, k_{d} is a coupled material-environment property that condenses the effects of plastic formulation and processing, and environmental conditions into a single term (i.e., values of k_{d} in seawater and soil are different).

Assuming a solid beam with a square cross-section, Equation 1 was solved to yield a relationship between environmental lifetime (t_{L}), the initial edge length of the cross-section (b₀), and k_{d} (Equation 2).

$${t}_{L} = \frac{{b}_{0}}{2 {K}_{d}} \qquad Eq . 2$$

Thus, minimizing t_{L} requires minimizing b₀ and maximizing k_{d}. However, this relationship is incomplete. The predefined design constraints dictate b₀. From beam theory, b₀ can be defined in terms of the tolerable deflection (δ) of the beam, the beam's initial length (l₀), the supported load (F), the loading and support configuration (C₁), and the Young's modulus (E) of the beam's material (a measure of a material's resistance to elastic deformation) (Equation 3).

$${b}_{0} = {( \frac{12 {Fl}_{0}^{3}}{{C}_{1} E δ} )}^{\frac{1}{4}} \qquad Eq . 3$$

Substituting Equation 3 into Equation 2 relates the environmental lifetime in terms of the design constraints (Equation 4). For more complex items, numerical methods (e.g., finite element simulations) can be used to solve Equation 2 for determining relationships between environmental lifetime and material properties, as done for other MIs.

$${t}_{L} = {( \frac{12 F}{{c}_{1} δ} )}^{1 / 4} {( \frac{{l}_{0}}{\sqrt[3]{16}} )}^{3 / 4} ( \frac{1}{{k}_{d} {E}^{1 / 4}} ) \qquad Eq . 4$$

Grouping the terms for material properties expressed in Equation 4, the MI for minimizing the persistence of a beam 50, FIG. 1A, with a solid square cross-section is

$$\frac{1}{{K}_{d} {E}^{1 / 4}} .$$

Notably, this MI implies that minimizing the beam's environmental lifetime requires considering a material's k_{d} and E. Using reported values for k_{d} and E of several plastics, functionally equivalent beams made from polycaprolactone (PCL) and polyhydroxyalkanoates (PHA) could be the least persistent, followed by cellulose diacetate (CDA), polyamide (PA), and polyurethane (PUR) (FIG. 1B). Conversely, functionally equivalent beams made from commodity polyolefins and several compostable polyesters would be expected to persist much longer. FIG. 1B is a selection chart for environmental lifetime estimation according to the present invention. Dashed lines 60 and 62 indicate contours of equivalent performance for the MI. The arrow 64 indicates the direction of better performance. Values of k_{d} are for seawater (marine) conditions with and without sunlight. Values are the combination of laboratory, mesocosm, and field experiments. Data for k_{d} are presented as mean±maximum and minimum values. Data for the Young's modulus (E) are presented as the median value.

In practice, products cannot solely be designed to minimize persistence at end-of-life; products must satisfy multiple, often competing, design objectives. Using literature data for several plastics, we calculated MIs to optimize a beam with a solid square cross-section in terms of financial (cost) and sustainability metrics such as embodied GHG (greenhouse gas) emissions and environmental lifetime. The choice of material had much greater effects on environmental lifetime than on cost or embodied GHG emissions. The median MIs for cost or embodied GHG emissions spanned less than one order of magnitude. In contrast, the MI for environmental lifetime spanned nearly three orders of magnitude as shown in FIG. 1C, which is a tradeoff chart comparing three MIs

$${M}_{1 = \frac{{c}_{m ρ}}{{E}^{1 / 2}} [ \frac{\$ USD}{{m}^{3} {MPa}^{1 / 2}} ]} ,$$

$${M}_{2 = \frac{{c}_{GHG ρ}}{{E}^{1 / 2}} [ \frac{kg co 2 - eq}{{m}^{3} {MPa}^{1 / 2}} ]} ,$$

$$and$$

$${M}_{3 = \frac{1}{{k}_{d} {E}^{1 / 4}} [ \frac{yr}{mm {MPa}^{1 / 4}} ]} .$$

Data are presented as median values. See Tables S2-S5 and S7-S9 below.

While polyethylene terephthalate (PET), polylactic acid (PLA), and polypropylene (PP) optimized indices for cost and embodied GHG emissions relatively well, these materials were poor choices for minimizing environmental lifetime. Polybutylene adipate terephthalate (PBAT) was one of the poorest choices for each MI, as indicated by its position near the upper right-hand corner of FIG. 1C. Comparatively, CDA, PA, PCL, PHA, and PUR had greater values of the MI for cost (i.e., more expensive than polyolefins), and variable values of the MI for embodied GHG emissions (i.e., CDA and PCL were lower, and PA, PHA, and PUR were higher than polyolefins). These same materials, though, had properties that reduced the MI for environmental persistence (i.e., shorter lifetimes than polyolefins).

While MIs are helpful, they cannot, on their own, quantify the tradeoffs between competing design objectives. To address this, value functions can be used to systematically weigh the relative value of any given combination of MIs by forming a compound objective for optimization. Value functions are defined by converting the performance (e.g., mass, energy, time) to value (e.g., monetary value or cost) using exchange constants (e.g., price per kg). Despite the challenges in determining them, several exchange constants for environmental impact have been proposed (See Table S10 below).

Because plastic products can persist in the environment as pollution, their impact is cumulative every year they remain. Therefore, we propose that the cost of plastic pollution (CP) (i.e., its value) can be defined as a performance-exchange constant pair of environmental lifetime and the cost of plastic pollution per mass of material per year in the environment. Accordingly, the cost of plastic pollution is realized as the product of the exchange constant (a_{L}) and the integrated mass over a product's environmental lifetime (Equation 5), where m is the instantaneous mass of the product from when it first entered the environment (t=0) to when it is completely degraded (t=tL).

$${C}_{P} = {α}_{L} {X}_{P} {f}_{P} {\int }_{t = 0}^{{t}_{L}} m dt \qquad Eq . 5$$

For the value of aL we propose using the economic cost of plastic pollution, estimated to be between $3,300 and $33,000 per metric ton of marine plastic per year (2011 $USD). This term underestimates the total cost of plastic pollution, as it only considers the toll on marine ecosystems, not the complete biosphere. To acknowledge that not every item leaks into the environment, we adjusted CP by multiplying by the total fraction of plastic leaking into the environment (X_{P}) and by the fraction with which a given type of item would contribute to the total amount of leaked plastic (f_{P}). Presently, society, not the manufacturer, bears the cost of plastic pollution, requiring discussions of policies for extended producer responsibility to acknowledge this cost.

For most geometries (those that retain the same morphology as they degrade), Equation 5 can be approximated by Equation 6 where m0 is an item's initial mass, and n is a dimensionless ‘shape factor’ (n is 1 for films, 2 for solid cylinders and beams, and 3 for spheres) (See Section 3 below).

$${C}_{P} = ( {α}_{L} {X}_{P} {f}_{P} ) ( \frac{{m}_{0} {t}_{L}}{n + 1} ) \qquad Eq . 6$$

Currently, billions of disposable coffee cup lids are used annually of which a fraction become pollution, accounting for ˜5% of plastic debris in nearshore waters. Thus, any savings from their environmental impact can yield significant benefits. In the following paragraphs, we use our framework according to the present invention to evaluate which on-the-market lid material reduces the environmental impact the most and determine which next-generation plastics are best and thus warrant adoption.

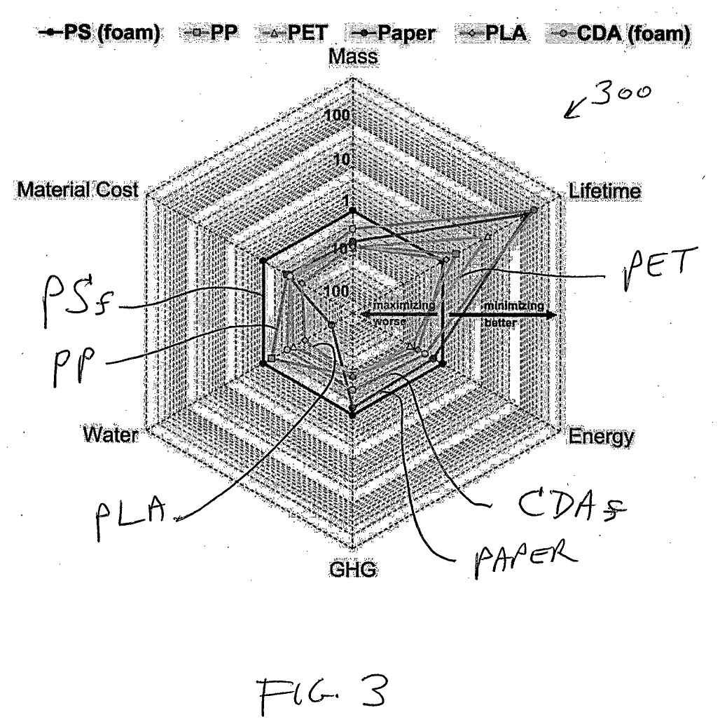

At present, disposable coffee cup lids are typically made from PLA, PP, or PS. Which material “best” reduces environmental impact, however, is non-obvious. FIG. 2A is a spider plot, also referred to as a “radar plot”, comparing MIs for mass, cost, embodied GHG emissions, water usage, and environmental lifetime of current and potential alternative plastics. Data are presented as the median values. Comparing MIs for several environmental impact categories included in LCAs (Life Cycle Assessments) indicated that of the three materials, PP was the best. PP minimized MIs for GHG emissions and water usage (FIG. 2A). Ironically, PP is one of the most abundant types of plastic found in marine garbage patches. Calculated value as the sum of the cost of material and the social cost of CO₂ per 1,000 lids expressed in 2016 USD for PP, PS, and PLA ranged from $9.17 to $10.72 for PP, $11.61 to $16.46 for PS, and $6.99 to $11.60 for PLA (FIGS. 2B-C). FIG. 2B is a comparison of the cost of material, FIG. 2C shows the social cost of CO₂, and FIG. 2D illustrates the cost of plastic pollution for current and potential alternative plastics. The social cost of CO₂ is the estimated societal damage due to anthropogenic CO₂ emissions. Data are presented as the minimum and maximum calculated values. See Tables S2-S8 and S11-S13 below. For the derivation of the MI for environmental lifetime of a lid, see Section 4 below.

Thus, overall, no material was much better than another. Though abridged, the result is not expected to change, given that conventional LCA impact categories trend well with GHG emissions.

Lid design should account for persistence. Of the three materials, PS was optimal for environmental lifetime (FIG. 2A). Including persistence (cost of plastic pollution) could increase the cost per 1,000 lids expressed in 2016 $USD for PLA and PP to over $200 while increasing the cost for PS to ˜$20. Our analyses suggest that PS may be the least impactful of the three materials on the market for disposable lids.

Our metric provides an opportunity not only to compare materials in use but also to identify less environmentally impactful alternatives. CDA, PBAT, PBS, and PHA are championed by many as alternative, more sustainable, degradable plastics for making consumer products. Comparing MIs, disposable lids made of CDA or PHA could provide more than an order of magnitude better performance for environmental lifetime while being comparable in other categories (FIG. 2A). PBAT and PBS were worse than current plastics for nearly all MIs (FIG. 2A). This result underscores the idea that bio-based, biodegradable, or compostable plastics are not a panacea for addressing the environmental impacts of plastics. Instead, our results suggest that a more nuanced understanding is needed, whereby some biobased plastics are robust alternatives (i.e., CDA and PHA), and others appear to exacerbate the problem (i.e., PBAT and PBS).

Notably, without accounting for persistence, the incentive to switch to these alternative plastics is weak, given their increased cost and limited reductions in GHG emissions (if at all) compared to current plastics (FIGS. 2B-C). However, adopting alternatives could be incentivized according to the present invention by emphasizing the value gained by reducing the cost of plastic pollution. Savings to the cost of pollution per 1,000 lids from switching to CDA or PHA compared to current plastics were estimated to range from $1.46 to $220.01 and −$0.40 to $220.49, respectively (FIG. 2D). Given the billions of lids consumed annually, these savings could translate to societal benefits of hundreds of millions of dollars for this item.

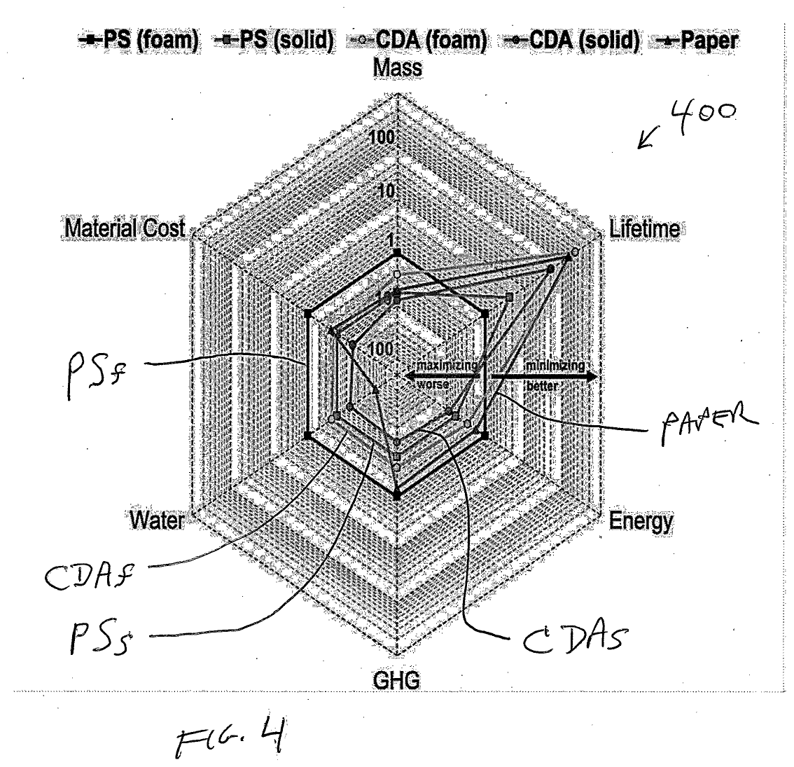

Spider plots 300 and 400, FIGS. 3 and 4, compare current and potential materials for making food trays and takeaway containers relative to PS foam (relative value of 1) for various performance, lifetime and environmental impact categories. Data points represent the relative MI or value for each material compared to PS foam and were calculated according to Equation 12 as presented further below. All foams are low-density. Data used for evaluating the MIs are shown in Supplementary Table S14 below.

These spider plots 300 and 400 compare different material indices (metrics for evaluating material performance) for several materials relative to PS foam. All values for PS foam are 1 because it is relative to itself. Materials that perform worse are enclosed within the hexagon (PS foam) with increasingly worse performance the closer the value is to the center (10× to 100×). For example, a 10× worse value is 0.1 of the value of PS foam. Conversely, materials that perform better are outside the hexagon (PS foam) with increasingly better performance the farther the value extends outward from the hexagon (10× to 100×). For example, for Water (water usage), all the materials perform worse than PS foam, paper is the worse by nearly 100× and CDA foam is the closest to PS foam performing about 2-3× worse. In contrast, for Lifetime, CDA foam performs much better than PS foam (nearly 100×) with paper just behind it.

System 500 according to one construction of the present invention, indicated by dashed lines in FIG. 5A, includes a k_{d} Database Module 502, an Environmental Lifetime Module 504 and a Design Objectives Tradeoff Module 506 that produces a Tradeoffs Report 508. System 500 interfaces with 3D Modeling Software 510, FEM/CFD (Finite Element Method/Computational Fluid Dynamics) Simulation Software 512 and a Material Property Database 514. In other constructions, databases 502 and 513 can be combined into one or more databases stored on non-transient media, and various software programs can be implemented by one or more processors. In certain constructions, additional operations to determine k_{d} are performed by k_{d} Module 502 as discussed below.

Operation of one implementation of system 500 proceeds as follows. Geometry of a 3D model of an object to be optimized is rendered by software 510 and is passed as assigned 3D geometry 1 to software program 512 capable of FEM/CFD simulation to produce a meshed geometry such as illustrated in FIGS. 8B and 9B and discussed in more detail below in relation to FIGS. 8A-9G. In other implementations, the geometry of the object is measured, estimated or otherwise obtained without 3D modelling. Material property data 2 for an assigned material is passed from the Material Property Database 514 to the FEM/CFD Simulation Software 512 for conducting simulations (e.g., mechanical, thermal, electrical, magnetic, flow, and other analyses). The meshed geometry 3 is passed to the Environmental Lifetime Module 504 for calculation of the object's environmental lifetime based on the geometry of the object, on the assigned material including its density, and on its specific surface degradation rate (k_{d}), which is passed as output 4a from k_{d} Database 502 to the environmental lifetime module 504 for use in the calculation of environmental lifetime. The specific surface degradation rate (k_{d}) is also passed in this construction as output 4b to the material property database 514 for reference with other material properties of a given material.

The Environmental Lifetime Module 504 determines an environmental lifetime value 5 which is passed to the Design Objectives Tradeoff Module 506. In this construction, a volume of the geometry is passed as geometry volume 6 to the Design Objectives Tradeoff Module 506. Similarly, the assigned density, material price, and specific (mass normalized) environmental impact properties such as GHG (embodied greenhouse gas emissions value) of the assigned material are passed as values 7 to the Design Objectives Tradeoff Module 506. Alternatively, in other constructions, volume 6 and values 7 are included in outputs 1, 2, 3 and 5 so that all relevant information is transmitted by Environmental Lifetime Module 504 to the Design Objectives Tradeoff Module 506. In yet other constructions, environmental lifetime information is passed as indicated by dashed arrow 5a to Simulation Software module 512 for iterative optimization as discussed in more detail below. Regardless of how such information arrives at Module 506, analysis is conducted and a report detailing the performance of the geometry using the assigned material with respect to the mass, cost, environmental impacts, and persistence is generated and sent as information 8 to be displayed, printed or otherwise viewable on an output device as Tradeoffs Report 508. Outputs by systems and methods according to the present invention include, but are not limited to, the charts and plots shown in FIGS. 1B-4 and FIGS. 10A-11C, for example. In some constructions, a user can select a Tradeoff reports to include visualization by spider plots, bar graphs, tables, etc. reporting the performance of the geometry for one or more materials with respect to at least mass, cost, environmental impacts, and environmental lifetime (persistence). Automated or user-input annotations and recommendations may be included. The performance criteria can be pre-specified by the user and included in the report

In some constructions, steps generating values 2-7 are iterated for different assigned materials to provide a comparison among materials such as in an “embodiment stage” of an iterative design cycle including concept, embodiment and detail stages. Alternatively, geometry values 1 are iterated using the same or different materials. For the detail stage of design, the design objectives tradeoff module uses exchange constants to calculate the material costs and external costs (social costs) of the geometry for the assigned material, which are passed as values 8 and reported at the tradeoffs report which, in some constructions, includes a final product specification for the object.

Iteration according to one construction of the present invention to achieve topology optimization for an object is illustrated in FIG. 5B. Geometry and material assignments are initialized, step 542, and geometry is meshed in FEM/CFD analysis, step 544, which is conducted according to structural/thermal/electrical/magnetic/flow conditions as appropriate for the particular object to be designed. An environmental lifetime is calculated for the object, step 546. An optimization method is applied, step 548, which can include sensitivity analysis, filtering, and/or evaluating multiple objectives such as target values pre-selected by a user. Additional FEM/CFD analysis may be provided as indicated by dashed arrow 549.

Convergence criteria is evaluated, step 550, such as whether results approach a limit, that is, whether iterative results become closer and closer to a particular number or value, preferably iteratively repeating two or more of the above steps with at least one changed assigned value until environmental lifetime converges to a value less than or equal to a pre-selected convergence criteria. If convergence is satisfied (“yes”) then optimal topology (geometry for the assigned material) is achieved, step. 552. If convergence at step 550 is not achieved as indicated by “no”, then the process iterates as indicated by arrow 551 which returns operation to FEM/CFD analysis, step 544 and resulting repeated steps. A similar iterative optimizing/convergence approach can be utilized for material selection according to the present invention.

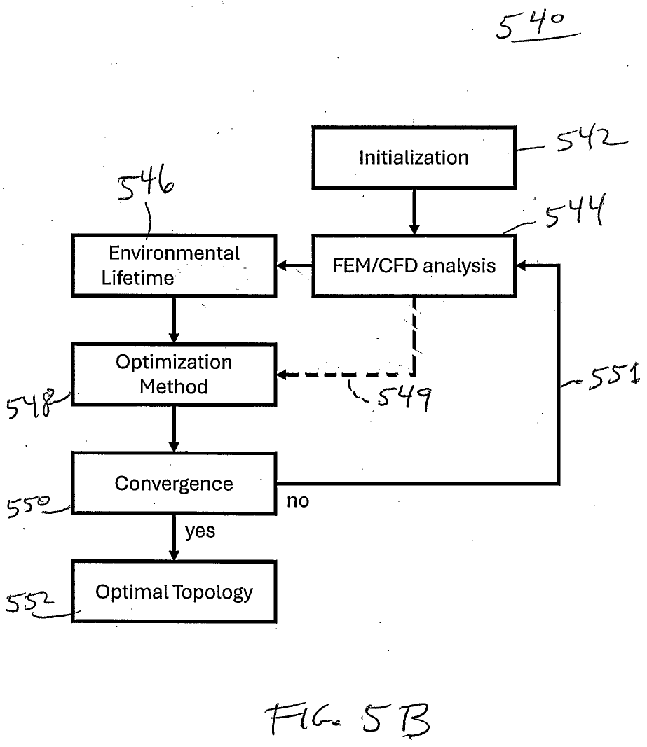

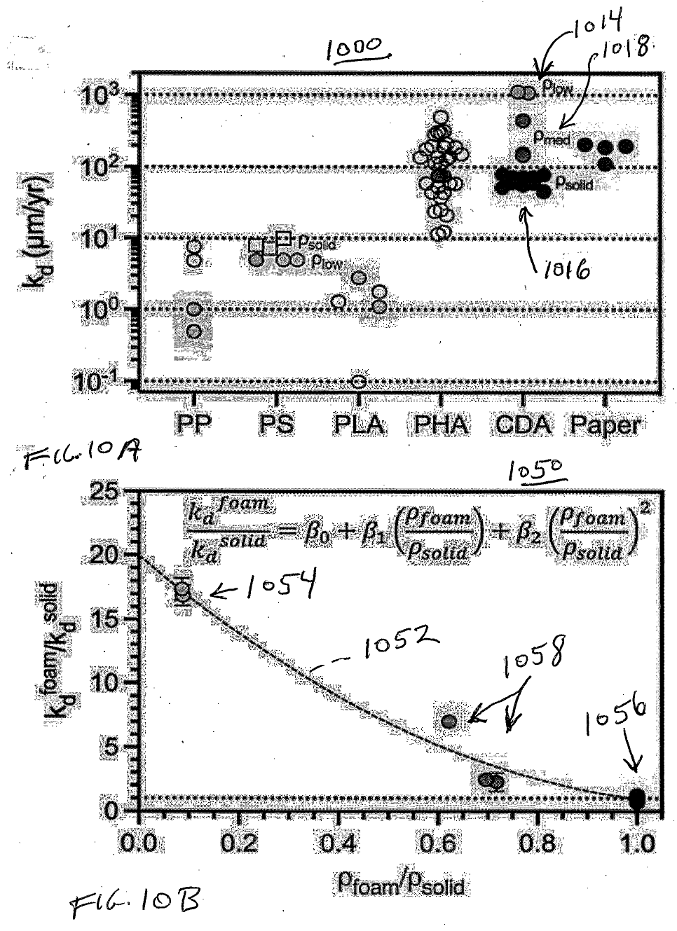

In some constructions according to the present invention, the database of specific surface degradation rate (k_{d}) can include (1) experimental data for mass loss or proportional to mass loss for which k_{d} can be determined and (2) mathematical models that predict k_{d} based on material (e.g., relative density, formulation) and environmental (e.g., temperature, microbial community composition) properties. Users of the mathematical models can then refer to an analysis such as provided in chart 1050, FIG. 10B, which is discussed below. In certain constructions, k_{d} Database 502 is a module that empirically determines k_{d} such as depicted in FIGS. 6 and 7. FIG. 6 is a schematic flowchart of process 600 according to the present invention to prepare a new plastic material including determining its specific surface degradation rate (k_{d}). An assigned polymer, step 602, and one or more additives, step 604, are combined as an assigned plastic formulation, step 606. The plastic is processed, step 608, to obtain assigned plastic material, step 610. Material property characterization is determined, step 612, with measurement of k_{d}, step 614, and measurement of other properties, step 616. This information is added to one or more databases, step 618.

FIG. 7 is a schematic flowchart of process 700 according to the present invention to evaluate degradation of samples over time to empirically determine k_{d}. The assigned plastic material is prepared as uniform test samples, step 702, and mass and geometric dimensions of test samples are measured, step 704. Test samples are placed in continuous flowing fluid tanks, step 706, with the fluid selected according to the environment (e.g., fresh water, seawater, sewage) selected for analysis. Test samples are retrieved at a designated time point, step 708, and mass of each retrieved sample is measured, step 710. Process 700 iterates steps 708 and 710 as indicated by arrow 712 over a preselected time period or until no mass remains for the samples, whichever occurs sooner. A value for k_{d} is then determined, step 714.

FIGS. 8A-8D are schematic diagrams of one process according to the present invention for analyzing solid samples. A geometry 800, FIG. 8A, is imported to FEM/CFD Simulation Software 512, FIG. 5A. A meshed geometry 802, FIG. 8B, is generated, with finite rectangular elements in this example. A medial axis of geometry is determined for geometry 804, FIG. 8C, with dashed axis lines 805. Distances between the center of the surface faces of each rectangular element directed along the inward facing normal and medial axis are calculated as indicated by arrows 810, 812 and 814, for example. The largest distance of all those calculated for all elements is selected as the characteristic length (L_{c}) of the geometry utilized to calculate the environmental lifetime (t_{L}). For fully solid objects (i.e., without internal voids), the t_{L} is calculated using the medial axis as shown without additional simulation.

FIGS. 9A-9G are schematic diagrams of a process according to the present invention for analyzing samples having one or more internal voids. Object 900, FIGS. 9A and 9C, is shown primarily as a solid with an internal void 902 at initial time to. Although a single void 902 is shown for simplicity in this example, it is readily apparent that additional voids can be calculated for other examples, including micro-voids such as found in foamed materials. For geometries with internal voids, simulation of a surface erosion process is required to calculate the environmental lifetime t_{L}. The geometry of object 900 with void 902 is imported to FEM/CFD Simulation Software 512, FIG. 5A. A meshed geometry 904, FIG. 9B, is generated, with finite rectangular elements plus void 902 in this example. Surface erosion is then simulated over multiple timesteps, FIGS. 9C-9G, for successive times tᵢ, tⱼ, tₖ and t_{L}. Successive degradation of the object is shown as stages 906 for t₀, then stages 908, 910, 912 (which shows two independent pieces remaining) and 914 (total degradation), respectively. Internal void 902 is breached between times tⱼ and tₖ in this example, which increases surface area to speed degradation. The environmental lifetime t_{L} is determined at the timestep for which the entire geometry is consumed, as shown in FIG. 9G for this example.

The present framework shows promise for designing more eco-compatible objects such as plastic products; however, informed decisions will only be as good as the data used to make them. While many studies have investigated degradation, a limited number have reported information sufficient to calculate the Specific Surface Degradation Rate k_{d}. Additionally, several studies were conducted using closed-system bottle incubations, which can lack environmental relevance because the plastic in question is used as the sole nutrient source of carbon. Results of these studies often report much faster degradation rates than those from more realistic mesocosm and field experiments (See Table S7 below). Moreover, the few reports of k_{d} pale compared to the vast number of plastic formulations contributing to the large variability across plastic types. For example, in the case of PHAs (FIG. 1B), k_{d} values span nearly two orders of magnitude. Consequently, while PHAs could be materials with the least cost of pollution (FIG. 2D), they could also be some of the more costly choices. In the case of PA, only one study has measured k_{d} (Table S7), making any estimate of PA lifetime and cost of pollution highly uncertain. Such tremendous variability and uncertainty pose significant challenges to material selection.

Moreover, while some studies demonstrate that k_{d} represents the mineralization of plastic to carbon dioxide, dissolution to dissolved organic carbon, or assimilation to biomass, many studies present no evidence of complete or partial transformation. This poses challenges in knowing whether k_{d} represents the chemical degradation (depolymerization) of the polymer or merely the physical degradation (disintegration) to microplastics. Regardless of the degradation process, the impacts of any degradation products released from plastic items must also be considered. Finally, a key challenge is that the molecular and microstructural features underpinning polymer degradation also control many other polymer properties (e.g., Young's modulus). Of the studies reporting data sufficient to calculate k_{d}, less than half included characterization of any physical and mechanical properties or provided enough details to determine them after the fact. Because the environmental lifetime of an item can depend on k_{d} and other material properties, making effective material selection decisions will require reporting comprehensive details of material properties along with k_{d}.

The metric we propose for minimizing environmental lifetime applies to mitigating terrestrial plastic pollution and waste destined for landfill or composting, although similar data limitations exist for k_{d} in these environments. Overall, a greater understanding of the environmental controls (e.g., sunlight exposure, temperature, nutrients, microbial communities) and structure-property-formulation relationships governing plastic degradation will improve predictions of k_{d} and resulting lifetime and cost of pollution estimates.

Additives and form factors: Plastics are polymers modified with organic and inorganic additives, constituting their formulation. Various compounds added to plastics or included in them as non-intentionally added substances can facilitate or inhibit the environmental degradation of plastics. For example, antioxidants and ultraviolet light stabilizers are added to plastics to protect them from thermal degradation during processing and photochemical degradation during outdoor use. Because plastics are typically thermally processed, most plastic products contain antioxidants, which can prolong plastic lifetimes compared to additive-free plastics. Other additives can intentionally (e.g., pro-oxidants, photocatalysts, enzymes, or microbes) or inadvertently (e.g., pigments, catalyst residues, and unsaturated bonds) enhance degradation. Additionally, the amount of polymer used to make a product can be reduced using fillers, thereby reducing lifetimes in proportion to the amount of filler used. While additives may prove helpful for reducing environmental lifetimes, their potential harm to human health and the environment must also be appreciated. Moreover, the intrinsic toxicity of plastic will require an MI to inform design decisions. Eco-compatible plastics must be made from eco-compatible polymers and eco-compatible additives.

A product's degradation rate is controlled by material and geometry (i.e., surface area). Topology optimization techniques and additive manufacturing can be utilized to design and fabricate products that maximize surface area and thus minimize environmental lifetime. Such strategies have already begun to be applied to some single-use items (e.g., cutlery) by redesigning them to remove structurally unnecessary material. Lattice-filled or foamed structures also achieve this objective. In particular, foamed items may have added benefits by keeping them in conditions more favorable to degradation because of their positive buoyancy and, thus, exposure to sunlight. Addressing the plastic pollution crisis will need less persistent plastics and innovative approaches to product designs.

Mismanaged plastic products should be designed to inherently reduce their environmental impacts by optimizing material efficiency and minimizing environmental persistence. Foaming biodegradable bioplastics (i.e., introducing microstructural pores into the material) was hypothesized to achieve this objective. To test this hypothesis, the marine biodegradation of novel cellulose diacetate (CDA) foams of varying relative density (ρ_{foam}/ρ_{solid}=0.09-1.00) was evaluated in a flow-through seawater mesocosm. After 36 weeks, the CDA foams (ρ_{foam}/ρ_{solid}=0.09) lost 65-70% of their mass, while equivalent polystyrene foams persisted with no change in mass. The degradation rates of the CDA foams were ˜15 times that of solid CDA and the fastest of any plastic reported in the ocean. Material indices, value functions, and qualitative descriptors for circularity indicated that CDA foams could be the favorable choice of material for food-packaging applications with potential benefits to society worth hundreds of millions of dollars annually. Foaming of biodegradable bioplastics thus represents a promising strategy toward minimizing the environmental impacts and persistence of frequently mismanaged consumer plastics.

The degradation of plastics in the environment is a surface-driven process that depends on the surface area-to-volume ratio (SA/V) of the item and the specific surface degradation rate of the material (k_{d}). The latter is a material property that quantifies the rate of surface erosion of a material in a given environment. The dependence on geometry suggests foams may degrade appreciably faster than their solid counterpart because of increased surface area.

The present inventors first validated that SA/V is a key control of the lifetime of CDA in the coastal environment, using solid CDA films (ρ_{solid}=1.35 g/cm³) of different thickness (1, 5, and 10 mil). The relative mass loss rates of the films trended linearly with SA/V (R²=0.996), being fastest for the 1 mil (SA/V=˜80) and slowest for the 10 mil (SA/V=˜8). Consequently, environmental lifetime depended on film thickness, scaling linearly with increasing thickness from ˜12 to ˜91 weeks for the 1 to 10 mil films, respectively.

The dependence of CDA lifetime on SA/V motivated the development of foamed CDA articles with increased SA/V and presumably shortened lifetime in the coastal ocean. We incubated a collection of CDA foams of varying densities in a flow-through seawater mesocosm and monitored their degradation over 36 weeks. Comparable PS foams were used as negative controls. These foams varied in thickness from 30 to 150 mil, in pore structure being either isolated or closed-cell, and in relative density (ρ_{foam}) from low density (<0.10) to medium density (0.60-0.70).

The CDA foams degraded rapidly under coastal seawater conditions. During the 36-week incubation, the extent of degradation for a 98-mil thick, low-density CDA foam was visually discernible as a progressive increase in the foam's transparency. The medium and low-density foams lost more than 35 and 65% of their mass by 36 weeks, respectively. At the microstructural level, the opening of the pores within the medium-density CDA foam was visible. Similarly, the cell walls and edges of the low-density CDA foams showed evidence of their degradation after 36 weeks. Comparatively, the PS foams had no measurable mass loss and no microstructural changes. Values of k_{d} for the PS foams were constrained to less than 5 μm/yr based on calculated mass loss trajectories for different values of k_{d} and the foam's geometric dimensions (i.e., length, width, and thickness).

The values of k_{d} for the thick CDA foams (30-115 mil) were substantially greater than those of the thin, solid CDA films (1-10 mil). The low-density CDA foams had values of k_{d} that were ˜15-fold greater than that of solid CDA. Accordingly, while a 1-mm thick solid CDA film would take an estimated 15-20 years to fully degrade in the coastal ocean, a low-density foam of the same dimensions would take less than a year. The value of k_{d} for the medium-density foam was double that of solid CDA (156+/−7 μm/yr. Comparatively, a prototype foam of a similar formulation and density investigated in Mazzotta et al. had a value of k_{d} about seven times that of solid CDA (445+/−26 μm/yr. The difference in the value of k_{d} for these two medium-density foams likely stemmed from differences in their pore size, shape, and distribution. The medium-density foam evaluated in Mazzotta et al. had smaller pores (average diameters of 46 vs. 68 μm) and more of them (cross-sectional areal densities of 177000 vs. 99000 pores/cm²) than the medium-density foam used in this study. Compared to foaming, plastic formulation (the use of filler and plasticizer) had a minor effect (<25% change) on the value of k_{d}.

FIG. 10A is a chart 1000 showing a comparison of the marine environment-specific surface degradation rate (k_{d}) of the different materials listed along the x-axis including solid CDA 1010, low-density CDA 1014 and medium-density CDA 1012, for example. Materials tested included CDA and PS foams of different densities (μ_{med,CDA}=0.94 g/cm³, μ_{med,PS}=0.62 g/cm³, μ_{low,PS}=0.05-0.08 g/cm³, and μ_{low}, CDA=0.12 g/cm³) and thicknesses of 30-mil for “medium” CDA foam and 98-mil to 115-mil for “low” CDA foam plus 30-mil for “medium” PS foam and 75-mil to 150-mil for “low” PS foam. Circles are data points from mesocosm or field-based experiments. Squares are data points from bottle-based experiments using weathered materials. Open symbols are data points from the literature. Filled symbols are data points empirically measured using our continuous flow-through mesocosm system from this study and previous studies including Mazzotta et al. (2022).

The values of k_{d} for the low-density CDA foams were the greatest reported for any plastic evaluated under environmentally relevant marine conditions as shown in FIG. 10A. Moreover, the values of k_{d} for the low-density CDA foams were more than quadruple that of paper and 100 to 1000 times greater than those of solid PP, PS, and PLA. As evidenced for PS, it is expected that foaming will not increase the value of k_{d} for solid plastics with k_{d} less than ˜10 μm/yr (i.e., PP and PLA in the marine environment).

The microstructural organization of foams is engineered to yield desired material properties (e.g., strength), thus understanding the relationship between foam microstructure and k_{d} affords predictive design and weighing tradeoffs between material properties. The reported value of k_{d} for the foams was an apparent k_{d} because these values were calculated using the macroscopic dimensions of the foams, not their microscopic dimensions. This treatment is consistent with that of other material properties for foams. As with other material properties determined in this way (e.g., moduli, strengths, and conductivities), relative material properties of foams can be connected to the ρ_{foam}/ρ_{solid} of the foam. The microstructural organization of the foam is directly related to its ρ_{foam}/ρ_{solid}. Accordingly, an empirical relationship was determined between the relative k_{d} for the CDA foams k_{d}^{foam}/k_{d}^{solid} with that of their ρ_{foam}/ρ_{solid} as shown in chart 1050, FIG. 10B. The dashed line 1052 shows a quadratic best fit for solid CDA 1056, medium-density CDA 1058 and low-density CDA 1054. The coefficients were determined from nonlinear regression analysis (R²=0.98); β₀ was 20.0+/−0.8, β₁ was −33.1+/−3.6, and β₂ was 14.1+/−3.1. Being empirical, the form of the equation and values of the coefficients are not definite; they are expected to change with more data.

A quadratic relationship fit the best compared to other possible relationships (e.g., linear or power law). Though preliminary, this relationship is instructive as it makes a first attempt at predicting k_{d} for foamed materials. The generalizability of this relationship to foams of other biodegradable polymers and environments remains to be determined. Future research should investigate the relationships between cellular architecture and k_{d} in more detail to rationally design foams for minimal persistence and optimal functionality, as can be guided by the present invention.

In addition to achieving material-efficient designs, foaming with biodegradable bioplastics achieves designs with minimal environmental lifetimes. Ashby showed that the most material-efficient design for stiffness and strength optimizes a material index (MI) that relates density (ρ) to Young's modulus (E) and yield strength (σy), respectively. See Ashby, M. F. Materials Selection in Mechanical Design, (Butterworth-Heinemann, 2016) (“Ashby”). As described elsewhere herein, material indices (MIs) are material properties or groups of them that optimize performance for a given objective (e.g., minimizing mass, cost, or environmental impact). The solid films and foam sheets investigated in our studies were evaluated using MIs for those geometries (Supplementary Table 14 below). By this measure, and as expected, the foams optimized these MIs compared to the solid material, and overall, the PS foams optimized these MIs.

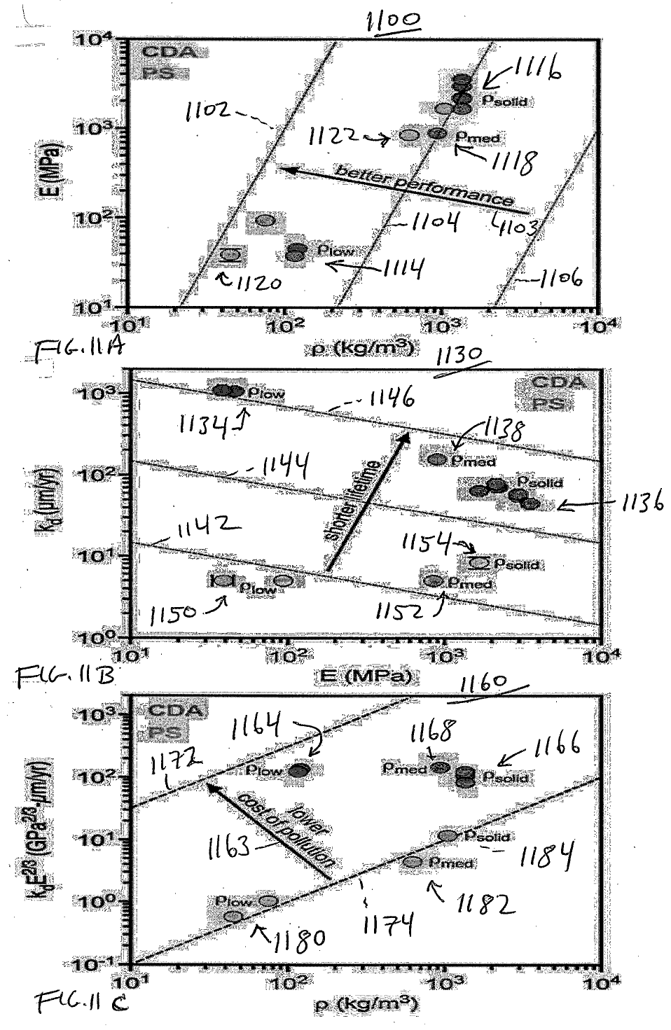

FIGS. 11A-11C are material property charts comparing ρ and E in chart 1100, FIG. 11A, k_{d} and E in chart 1130, FIG. 11B, and ρ and k_{d}E^{2/3} in chart 1160, FIG. 11C, for CDA and PS. Dashed lines represent isolines of equivalent performance, i.e., the value of the MI for material efficiency as isolines 1102, 1104 and 1106 (FIG. 11A), minimal environmental lifetime isolines 1142, 1144 and 1146 (FIG. 11B), and minimal social cost of plastic pollution isolines 1172 and 1174 (FIG. 11C). Material property charts for yield strength in place of Young's modulus reflected the same trends.

Chart 1100, FIG. 10A, shows better performance for PS 1120 and 1122 compared to low-density CDA 1114, medium-density CDA 1118 and solid CDA 1116, as indicated by performance arrow 1103 which shows better performance approaching isoline 1102.

Recently, we applied Ashby's method of material selection to derive MIs for minimal environmental lifetime. With respect to mechanical performance, such MIs relate k_{d} to E and σy. Low-density CDA foams optimized these Mis as shown in chart 1130, FIG. 11B, for low-density PS foam 1150, medium-density PS foam 1152 and solid PS 1154 relative to low-density CDA 1134, medium-density CDA 138 and solid CDA 1136. Shorter lifetime is indicated by arrow 1133 approaching isoline 1146. As for PS, foaming provided no benefit to reducing the environmental lifetime of items made of this material because the material was persistent, as shown by isoline 1142.

Minimizing the environmental impact of a leaked item requires minimizing both mass and environmental lifetime. The MIs for each objective were combined into a compound MI of material efficiency and minimal environmental lifetime as the product of the two individual MIs. For stiffness-limited design, the compound MI was ρ/k_{d}E^{2/6} and for strength-limited design, the compound MI was ρ/k_{d} σy.

Optimizing these MIs results in selecting the material that best reduces the social cost of plastic pollution, which depends on the initial mass and the environmental lifetime of the item. Social costs reflect the external costs (e.g., air pollution on human health) to society associated with a good, service, or outcome (e.g., combustion engines). Whereas foaming proved no benefit in optimizing these MIs for PS, it yielded increased material performance (lowering the social cost of plastic pollution) by 10-20 times for CDA, as shown in chart 1160, FIG. 11C for low-density CDA 1164, medium-density CDA 1168 and solid CDA 1166 relative to low-density PS 1180, medium-density PS 1182 and solid PS 1184. At equivalent densities, CDA optimized these MIs compared to PS as indicated by lower cost of production arrow 1163 approaching isoline 1172.

Redesigning single-use food trays and takeaway containers for circularity and minimizing environmental impacts: Food containers and packaging rely on plastic materials because of their low cost, durability, material efficiency, and food preservation qualities. Packaging raw meat on food trays and storing food in takeaway containers are two applications in which plastic materials have excelled. Both items are predominantly made of PS foam and, to a lesser extent, polyethylene terephthalate (PET), PP, PLA, and paper. Historically, an estimated 10-20 billion PS foam food trays and 6-7 billion PS foam takeaway containers (e.g., clamshells) have been used annually in the United States. According to meta-analyses of LCAs of food trays and takeaway containers, among these materials, PS foam is one of the best choices for the environment. However, these LCAs do not account for the environmental impact of mismanaged plastic. Foamed articles, including food trays and takeaway containers, routinely leak into the environment. For example, foam takeaway containers greatly contribute to coastal marine plastic pollution, constituting ˜15% of plastic collected in beach surveys. Therefore, foamed food trays and takeaway containers may benefit from redesigning them to follow the principles of green chemistry and engineering. Given the diversity of available materials, there is a need to re-evaluate the best choice for the environment and determine whether alternative materials can do better.

Selection using material indices (MIs): Material selection using MIs for several functional indicators and environmental impacts can inform decision-making. Food trays and takeaway containers are formed films and foamed sheets; thus, for eco-informed material selection, MIs for stiff and strong films and sheets were evaluated to compare materials used for these items and potential alternative materials. Indices for material efficiency, material cost efficiency, GHG emissions, energy usage, water usage, and environmental lifetime were calculated for each material (Supplementary Table S14 below and FIGS. 3-4), thereby covering a broad range of functional, economic, and environmental design considerations.

Three key observations resulted from this analysis. First, the MI for environmental lifetime indicated that CDA foam was optimal (215 times better than PS foam), followed by paper (146 times better than PS foam) and PET (14 times better than PS foam). Second, the MI for embodied water usage spanned a wide range of values, reflecting the major differences in the water requirements used by the feedstock and in processing the materials. PP, CDA foam, and PET were 2, 4, and 6 times less optimal than PS foam, respectively. PLA and paper were even poorer choices compared to PS foam by 11 and 57 times, respectively. Third, for all other MIs, PS foam was the optimal material. However, the ranges in values for these MIs were far less than for environmental persistence and water usage. By and large, and in agreement with previous LCAs, the MIs indicated that PS foam could be the best choice of material when persistence is not a factor. However, when persistence is considered, CDA foam can be the best choice. As noted, the current standing of each material was based on what we know now and is subject to change with new and improved data. One way for biodegradable bioplastic foams to be more competitive with PS foams across all these metrics is to attain greater material efficiency by moving to lower relative densities (<0.10).

Selection by balancing tradeoffs of economic and societal costs: Tradeoffs between MIs were considered using value functions to systematically evaluate characteristics with a standard unit, i.e., dollars. MIs are converted to value using exchange constants. Owing to available and robust exchange constants, comparisons were made in terms of the relative cost of materials and the relative social cost of CO₂ for each material with respect to PS foam (FIG. 3). Regarding the cost of materials, PS foam was the least expensive. The amounts of other materials used to make food trays and takeaway containers were estimated to be 4 to 5 times more expensive. This difference translates to an additional cost of material <$0.10 more per item, which is likely negligible to the consumer with respect to the cost of the food held by the items (e.g., cost of meat). As for the social cost of CO₂, PS foam was the best choice, being 1.4 to 7.4 times less costly than the other materials. Presently, the latest estimate for the value of the exchange constant for the social cost of CO₂ is 0.22 $USD/kg CO₂. Scaled to the annual consumption rate of food trays and takeaway containers used in the U.S., the annual social costs of CO₂ associated with PS foam food trays and takeaway containers were ˜$49-98 million and ˜$30-34 million, respectively. To date, no exchange constant exists for the social cost of water, though the need to determine such a number has been proposed35. Nonetheless, water is a valuable natural resource; thus, reducing its usage as much as possible can benefit society.

An initial estimate for the social cost of plastic pollution was proposed to range between 4.58 to 45.8 $USD/yr-kg plastic. Based on the range of values for the social cost of plastic pollution, 2-18% of CDA foam food trays and 15-100% of CDA foam takeaway containers would need to leak into the environment for the social cost of plastic pollution to exceed the social costs of CO₂. A rough estimate for the leakage frequency of plastic foam is ˜2% (calculated as the product of the global plastic leakage frequency, ˜11%, and the proportion of leaked plastic that is plastic foam, ˜15%). Conversely, for persistent PS foams, only 0.02-0.2% of food trays and 0.2-2% of takeaway containers would need to leak for the social cost of plastic pollution to outweigh that of CO₂. The difference in the range of leakage frequency for food trays and takeaway containers was because of their ten times difference in thickness, which results in different environmental lifetimes and thus different social costs of plastic pollution.

A conservative estimate using the lower bound U.S. annual consumption rates for each item, the lower bound initial estimate for the social cost of plastic pollution, and assuming only 0.5% of these items leak into the environment, suggests that switching from PS to CDA foam could equate to annual savings for society due to a reduction in the cost of plastic pollution of ˜$1.6 billion for food trays and ˜$114 million for takeaway containers. These savings are also conservative because they do not reflect costs associated with circularity and renewability, as discussed in the following section. Moreover, regardless of the value of the exchange constant, the savings to society by using non-persistent materials are inherent; they are baseline savings that do not rely on changes in consumer behavior or waste management infrastructure.

Renewability and circularity considerations: Selection cannot be made solely using MIs and value. System-level properties of the material and product must be considered, such as feedstock renewability, end-of-life management, product recyclability, and circularity. To fit into a circular economy framework, a renewable feedstock is one in which the carbon has been recirculated, including carbon obtained from biomass, industrial by-products, waste CO₂, or recycled plastics. While all of the plastics discussed can be made in whole or in part from bio-based feedstocks, several are disproportionately petroleum-derived (PS foam, virgin PET, PP). The social costs of petroleum-derived feedstocks extend beyond CO₂ emissions, water usage, and environmental persistence discussed above. For example, human and ecosystem health impacts from oil spills, and methane venting by the oil and gas industry pose substantial social costs that are not considered in the current framework but can be evaluated according to the present invention such as shown in FIGS. 3 and 4. Meanwhile, the sustainability of PLA, CDA, and paper feedstocks depends on agricultural practices, which can vary considerably. CDA has historically been a mixed feedstock wherein the cellulose was bio-derived, and the carbon within the acetyl modification was derived from coal. Recognizing the non-renewability of coal as a carbon source for the acetyl functionality, more sustainable grades of CDA are being produced in which the acetyl carbon is derived from molecularly recycled mixed waste that would otherwise be landfilled.

Today, the vast majority of managed plastic waste is landfilled, some is incinerated, and even less is recycled and composted. For example, municipal mechanical recycling facilities currently do not accept foams, resulting in their disposal in landfills or by incineration. Landfills contribute ˜10% of global methane emissions, and their leachates can diminish fresh and groundwater resources. Although incineration of waste can reclaim embedded energy, the process releases GHGs and reduces air quality. The social costs of methane emissions and air pollution were estimated to be $3.5 per kg CH₄ (˜16 times that of CO₂) and to range from $100-172 per kg particulate matter with a diameter less than 2.5 μm (PM2.5) (˜450-782 times that of CO₂), respectively. While direct exchange constants for the social costs of landfilling and waste incineration are challenging due to their dependencies on geographic location and facility specifications, these figures for methane and PM2.5 emissions illustrate the magnitude of their costs to society and in turn, the potential costs of these waste management strategies.

More circular end-of-life strategies (e.g., recycling and composting) for the materials discussed require technological advancement, infrastructure investment, and consumer education. Foam materials can still be disposed of in ways that fit into a circular economy. PS materials, including PS foams, can be chemically recycled, though such capabilities have yet to become mainstream. PET is the most mechanically recycled plastic (˜21%, primarily from bottles) and is the only plastic being molecularly recycled at the commercial scale. PP can also be mechanically recycled, but so far has been at a reduced frequency (5.5%). While mechanical recycling can be a helpful end-of-life strategy for PET and PP, using recycled material to produce new food contact items poses challenges. Needing to be food-grade can limit the stock of mechanically recycled plastic available for use in making food trays and takeaway containers. A similar challenge to the mechanical recycling of plastics is material contamination, which is ubiquitous when these materials are used in food applications.

These facts skew the material selection analysis toward materials that can be disposed of alongside food waste and biodegraded in composting settings. Like PET and PP, paper is also recyclable but differs in that it is also compostable. Paper products often are coated to prevent leakage from liquids. These coatings are a recognized shortcoming of paper products, posing challenges to composters as sources of plastic contamination. Historically, they have included persistent per- and polyfluoroalkyl substances (PFAS); however, next-generation coatings, such as biowaxes and PLA, have begun to be phased in. PLA can be industrially composted; however, without improvements in the availability and accessibility of such facilities, PLA items may follow a linear lifecycle. Conversely, CDA can be home-composted, enabling a broader range of end-of-life disposal methods for this material. While composting is not a panacea without environmental impacts, it presents a path to circularity for mixed, readily biodegradable organic waste. Future work should prioritize the development of robust exchange constants for beginning- and end-of-life scenarios so their tradeoffs can be compared, like those for GHG emissions, water usage, and environmental lifetime.

The CDA materials used in this solid vs. foamed material study included formulated films (1 mil, 5 mil, 10 mil thicknesses), a film (10 mil thickness) formulated like the others but with the addition of 15 wt % CaCO₃ filler, a formulated medium density foam (30 mil thickness), and two formulated low-density foams (98 mil and 115 mil thicknesses). The 1 mil CDA film was prepared by solvent casting, while the 5 and 10 mil CDA films were prepared by melt extrusion. The CDA materials were formulated with a nontoxic, biodegradable additive commonly used as an ingredient in processed foods. All CDA materials were provided by Eastman. Details on the materials can be found in published patents.66 PS foams included a medium-density foam (30 mil thickness) and two low-density foams (75 mil and 150 mil thicknesses) provided by Eastman. All foams were thermoformed. The molecular weight, and thermomechanical and physical properties of the CDA films and CDA and PS foams are summarized in Supplementary Tables 2-5 below. Other materials included a biaxially oriented PP film (2 mil thickness) sourced from Goodfellow (PP30 grade), a PLA film (10 mil thickness) provided by Eastman, and a low-density grade, thermally upgraded kraft paper (10 mil thickness) sourced from the Cottrell Paper Company. PP and PLA films and PS foams were used as negative controls, and kraft paper was used as a positive control.

The molecular weight distribution of the CDA and PS materials were measured by GPC using an Agilent 1260 Infinity II High Pressure Liquid Chromatogram Separations module, with an on-line ultraviolet (UV) detector fitted with a deuterium lamp operating at 230 nm (Agilent 1260 Infinity II Variable Wavelength Detector), an interferometric refractometer (Agilent 1260 Infinity II Refractive Index (RI) Detector) operating at 30° C. with a tungsten lamp, and 5 μm PLgel Guard, MIXED-C, and Oligopore columns (Polymer Laboratories Inc.) in series. The mobile phase was tetrahydrofuran (THF) with butylated hydroxytoluene (BHT) preservative delivered at a 1 mL/min flow rate. 12.5 mg of the plastic sample was pre-dissolved in 5 mL THF with BHT preservative. The injection volume was 50 μL. The UV and RI detector signals were simultaneously recorded using Agilent SEC/GPC software version A.02.01 build 9.34851. The number average molecular weight (Mn), weight average molecular weight (Mw), and dispersity (D) were calculated in the software from the measured molecular weight distribution.

Cross-sectional micrographs of the foam samples were captured by scanning electron microscopy (SEM). First, the samples were cryo-sliced and sputter-coated with gold for 4 minutes under an argon atmosphere. Micrographs were obtained using a TESCAN VEGA SEM with an acceleration voltage of 5 kV and magnifications between 50 and 500 times. The pore and cell sizes were determined using a Python-based watershed segmentation script. Micrographs captured at high magnification that featured >50 distinct pores or cells were used for analysis.

The apparent densities of the foams were provided by Eastman. Relative densities for the foams were calculated as the ratio of the density of the respective foam to the density of the solid (CDA=1.35 g/cm3; PS=1.05 g/cm3). Porosities for the foams were calculated as one minus their respective relative density.

Details of the seawater pumping, filtering, and temperature tempering can be found in Mazzotta et al. without modification. The 20° C. tempered seawater collected in a head tank and flowed to the mesocosm tanks with an average flow rate of 218 L/hr, yielding a residence time of ˜30 minutes. Samples were suspended ˜2-3 inches from the bottom of the tank and held by clamps.

All samples were cut to ˜25.4 mm by ˜25.4 mm (1 inch by 1 inch) pieces as used previously by Mazzotta et al. Before placement in the mesocosm tank, all samples were massed using a Mettler Toledo AG245 (readability of 0.1 mg; repeatability of 0.1 mg). The same analytical balance was used for the entirety of the time series.

At designated time points, samples were collected, photographed, and placed into pre-weighed 15 mL glass vials filled with MilliQ water and incubated for ˜30 minutes. After the incubation, samples, and vials were lightly rinsed with copious amounts of MilliQ water to remove detritus. Then, samples in their respective vials without caps were placed open to dry at 60° C. for 48 hrs in an IsoTemp 637G oven (Fisher Scientific). Samples in their vials were then removed from the oven, closed, allowed to return to room temperature, and massed.

Mass loss measurements: Each sample at each time point was evaluated for mass loss in triplicate. Mass loss was calculated as the relative mass loss (%) being the difference between the initial mass of the sample (m₀) and the mass of the sample (mₜ) at the time point (t) normalized to the initial mass of the sample (Equation 7):

$$Mass loss ( \% ) = \frac{{m}_{0} - {m}_{t}}{{m}_{0}} ( 100 \% ) \qquad Eq . 7$$

Measurements were reproducible and repeatable over multiple years and seasons to reflect changes in temperature and other environmental conditions.

Mass loss is a reasonable measure for the degradation of CDA materials because it is well-established that these materials biodegrade to CO₂ in the coastal ocean. Additionally, because SA/V is a control of biodegradation if any mass loss were attributed to physical disintegration (fragmentation), this would only increase the fragments' mass loss rate (Equation 8 below). Thus, for mass loss measurements in our continuous flow-through seawater mesocosm, k_{d} was considered the surface erosion rate due to biodegradation processes. Additionally, samples in our system experienced negligible mechanical deformation and abrasion; the low flow rates were unable to deflect hanging samples (average flow velocity: ˜4 mm/s), indicating a very low shear rate, and the use of seawater filtered to particulate less than 200 μm in combination with low flow rates presumably minimizes any abrasive removal of material. Previous experiments have determined that no mass loss occurred in sterilized controls.

The relative mass loss data was fit to a phenomenological surface erosion model (Equation 8) in which ∂m/∂t is the change in mass with time, m is the instantaneous mass, k_{d} is the specific surface degradation rate, Aₛ is the surface area, and V is the volume:

$$\partial m / \partial t = - m {k}_{d} As / V \qquad Eq . 8$$

Equation 8 was solved for a film of initial length l₀, initial width w₀, and initial thickness h₀ and shifted and scaled using a constant β to account for mass loss due to leachable components (e.g., plasticizer) or other initial jumps in mass loss between the initial mass and the first time point to yield Equation 9:

$$Mass loss ( \% ) = 100 \% [ ( 1 - \frac{( {l}_{0} - 2 {k}_{d} t ) ( {w}_{0} - 2 {k}_{d} t ) ( {h}_{0} - 2 {k}_{d} t )}{{l}_{0} {w}_{0} {h}_{0}} ) ( 1 - β ) + β ] \qquad Eq . 9$$

Thus, the trivial data point of zero mass loss at time zero was excluded from model fitting. The variables l₀ and w₀ were assumed to be 25.4 mm for each sample, which is valid because Equation 9 is largely insensitive to changes in l₀ and w₀ when l₀>>h₀ and w₀>>h₀ as is the case for the film samples.

The relative mass loss data was fit to Equation 9 using nonlinear least-squares regression. Data sets for the CDA films were fit after a robust regression and outlier (ROUT) removal step with a coefficient Q of 1% to clean the data of any outlying points. All fits had R2 >0.90. Relative mass loss data for PP and PLA films, and PS foams were not fit because any mass loss was within the uncertainty of the mass loss measurements. Instead, mass loss trajectories were constrained for these materials using specified values of k_{d} and the sample's dimensions. All regressions were performed in GraphPad Prism 10.1.0 (264). Projected environmental lifetimes (tr) were calculated using Equation 10:

$${t}_{L} = {h}_{0} / 2 {k}_{d} \qquad Eq . 10$$

Data was collated from literature sources for material properties not measured in this study. Material indices (MIs) used to evaluate the performance and the environmental impact of the materials were derived for the design of stiffness-limited and strength-limited films or sheets, for which the free variables were the thickness of the film or sheet and the choice of material. MIs included those for material efficiency, material cost efficiency, minimal greenhouse gas (GHG) emissions, minimal energy usage, minimal water usage, and minimal environmental lifetime (Supplementary Table S14). To evaluate tradeoffs between MIs, a value function (V) was used to convert performance to monetary value using exchange constants in Equation 11:

$$V = {m}_{0} ( {C}_{\$} + {a}_{GHG} {C}_{GHG} + {a}_{water} {C}_{water} + {a}_{pollution} \frac{{h}_{0}}{4 {k}_{d}} ) \qquad Eq . 11$$

where m₀ was the initial mass of the item, C_{$} was the specific price of the material, aGHG was the social cost of CO₂, CGHG was the specific embodied GHG emissions of the material, a_{water} was the social cost of water usage, C_{water} was the specific embodied water usage of the material, aₚₒₗₗᵤₜᵢₒₙ was the product of the frequency for an item to leak into the environment and the social cost of plastic pollution, h₀ was the initial characteristic length (i.e., the thickness of the film or sheet), and k_{d} was the specific surface degradation rate. The relative value was used to calculate the value of hypothetical items that satisfied the same engineering requirements as a reference item of known dimensions and mass.

The relative value for the nth component of the value function between the ith material and reference material can be expressed by Equation 12:

$${( \frac{{V}_{i}}{{V}_{ref}} )}_{n} = {( \frac{{MI}_{i}}{{MI}_{ref}} )}_{n} \qquad Eq . 12$$

The comparisons between the social cost of plastic pollution and the social cost of CO₂ for food trays and takeaway containers made of the ith material were calculated according to Equation 13:

$$Eq . 13$$

$${( \frac{{V}_{pollution}}{{V}_{GHG}} )}_{i} = \frac{{( \frac{{m}_{0} {h}_{0}}{4 {k}_{d}} )}_{ref} {( \frac{{MI}_{i}}{{MI}_{ref}} )}_{mass} {( \frac{{MI}_{i}}{{MI}_{ref}} )}_{lifetime} {ε}_{pollution} {f}_{leakage}}{{( {m}_{0} )}_{ref} {( \frac{{MI}_{i}}{{MI}_{ref}} )}_{mass} {( {C}_{GHG} )}_{i} {a}_{GHG}}$$

where εₚₒₗₗᵤₜᵢₒₙ was the social cost of plastic pollution, f_{leakage} was the frequency the item leaks into the environment. Notably, Equation 13 demonstrates a dependence on article thickness.

Reference items included a PS foam food tray with an initial mass (m₀) of 8.98 g and an initial thickness (h₀) of 4 mm and a PS foam takeaway container with an initial mass (m₀) of 7.8 g and an initial thickness (h₀) of 0.46 mm, which had been evaluated by LCA. All dollar values were adjusted for inflation using the U.S. Bureau of Labor Statistics CPI Inflation calculator and are presented in 2024 U.S. dollars.

Social considerations: Engineering programs accredited by the Accreditation Board for Engineering and Technology (ABET) are required to teach environmental design considerations; however, most engineering students do not receive training on the persistence of materials in the environment. According to ABET review criteria, only environmental engineering curricula are explicitly required to teach about the fate and transport of materials in the environment. This limited specificity in accreditation criteria is reflected in practice. For example, a review of 24 undergraduate material science and engineering programs (with or without ABET accreditation) across research-intensive universities (R1) in North America demonstrated that eco-design might only be taught within ˜30% of material selection courses. Thus, ˜70% of engineers may enter the workforce without receiving mandatory curricular instruction on the environmental impact of materials and their tradeoffs. Incorporating our novel metric and others (e.g., for microplastic formation) into material selection and design courses thus represents an opportunity to train the next generation of engineers about eco-design and close the sustainability gap in materials education.

Local communities have already begun regulating single-use plastic products (e.g., bans on straws, grocery bags, and bottles). Yet often, consumers are without recommendations for products made from alternative materials. Like product designers, consumers need strategies for making the “best” material selection choices for the environment. We recommend implementing a simple, quantitative persistence label for plastic products that can complement existing eco-labels (e.g., Energy Star) to inform consumers about the persistence of plastic materials in the environment.

Globally, negotiations for an international plastics treaty are underway. The eco-design framework presented herein for mitigating environmental persistence should be considered part of the resolution. Material indices provide quantitative metrics for benchmarking materials during the design process that could be integrated with other sustainability metrics to define regulatory criteria in policy.

### Supplemental Information:

Material property data was collated from the literature and databases to determine the range of density (ρ), Young's modulus (E), specific price, specific embodied greenhouse gas (GHG) emissions, and specific water usage for each plastic investigated. See Tables S1-S13 below. Exact data sources for each property and plastic are referenced in Tables S2-S6. Specific surface degradation rate (k_{d}) data were calculated from primary reports and collated from reviews in the peer-reviewed literature. Exact data sources for each value of k_{d} are referenced in Table S7 and summarized for each plastic in Table S8 below.

Conventional coffee cup lids: Lid thickness was measured with a digital caliper of an excised piece from the flat section of the middle part of each lid. The density of each lid material was determined as the ratio of the mass of the excised piece and the volume of the piece calculated from its geometric dimensions. Lid thickness, mass, and density are included in Table S10. Material indices (MIs) presented in FIG. 2A were calculated using median values for Young's modulus, specific price, specific embodied greenhouse gas emissions, and specific water usage (Tables S2-S6) and the mean value for specific surface degradation rate (Table S8).

To calculate the mass and thickness of lids made from alternative plastics, the on-the-market lids' mass and thickness were linearly related to the inverse cube root of their material's median Young's modulus value. This relationship was used because we assumed the lids could be treated as thin, simply supported disks, which have an MI of

$$\frac{1}{\sqrt[4]{E}} .$$

For the on-the-market lids, this fit had an R2 of 0.88 for thickness and 0.97 for mass. Using these linear relationships, the mass and thickness of hypothetical lids made from cellulose diacetate (CDA), polybutylene adipate terephthalate (PBAT), polybutylene succinate (PBS), and polyhydroxyalkanoates (PHAs) were interpolated or extrapolated (Table S11).

With the mass and thickness of on-the-market and hypothetical lids made from alternative materials, value functions were computed, including the cost of material, the social cost of CO₂, and the cost of plastic pollution. The cost of material was calculated by multiplying the mass of the lid (Tables S10-S11) with the upper and lower values of specific price for the respective lid material (Table S4). The social cost of CO₂ was calculated by multiplying the mass of the lid (Tables S10-S11) with the upper and lower values of the specific greenhouse gas emissions (Table S5) and the mean social cost of CO₂ per kg of CO₂ adjusted to June 2016 $USD ($0.173/kg CO₂). The environmental lifetime of each lid was calculated by dividing the thickness of each lid (Tables S10-S11) by twice the upper and lower values of the specific surface degradation rate (Table S8). The cost of plastic pollution of each lid was calculated using Equation 6 with n=1, $19.36/kg/year for the median cost of plastic pollution per kg of plastic per year in June 2016 $USD, 0.11 for the total fraction of plastic leaking into the environment, 0.05 for the fraction of lids contributing to the total amount of leaked plastic, the mass of each lid (Tables S10-S11), and the calculated environmental lifetimes of each lid.

The upper and lower bounds for the cost of material, the social cost of CO₂, and the cost of plastic pollution for each lid are included in Table S12.

Section 1. A complete derivation of an MI for minimizing mass. Function: Light, stiff beam. Objective: Minimize mass (m). Constraints: Deflection (δ), beam length (l₀), loading (F), configuration (C₁). Free variables: Cross-sectional area (A_{c}), material of choice.

Consider the design of a light, stiff beam. Its function is to support a given load without sagging. A typical objective is to minimize the beam's mass. The constraints define the loading conditions, amount of tolerable deflection, and geometry (for this example, the length of the beam). The free variable(s), those that are unconstrained, are the choice of material and some geometric feature(s) (for this example, the cross-section of the beam).

To meet the objective, the mass (m) of the beam can be parameterized in terms of the constraints. First, the mass of the beam is defined by Equation S1, where ρ is the density of the beam's material, V is the volume of the beam equal to the product of the beam's cross-sectional area (Ac) and its length (l).

$$m = ρ V = ρ {A}_{c} l \qquad Equation S 1$$

To satisfy the mechanical constraints for the beam requires defining the relationship between the deflection of the beam, loading configurations, and the beam's geometry and material properties. The deflection (δ) of a beam can be determined using Equation S2, where F is the load, C₁ is a constant defining the loading and support configuration, E is the Young's modulus of the beam's material, and/is the second moment of area for the beam's cross-sectional geometry.

$$δ = \frac{{Fl}^{3}}{{C}_{1} El} \qquad Equation S 2$$

Assuming a solid square cross-section for the beam, the second moment of area can be calculated using Equation S3, where b is the edge length of the square cross-section.

$$I = \frac{{b}^{4}}{12} \qquad Equation S3$$

Rearranging and combining Equations S2 and S3, the requisite edge length can be defined by the loading conditions and geometry (Equation S4).

$${b}^{2} = \sqrt{\frac{12 {Fl}^{3}}{{C}_{1} E δ}} \qquad Equation S4$$

Therefore, substituting Equation S4 into Equation S1, the mass of the beam, as determined by the constraints, gives Equation S5.

$$m = ρ l \sqrt{\frac{12 {Fl}^{3}}{{C}_{1} E δ}} \qquad Equation S5$$

By grouping terms as functional (F, C₁, δ), geometric (l), and material (ρ, E), the different parameters that define the beam's design can be ascertained (Equation S6).

$$m = {( \frac{12 F}{{C}_{1} δ} )}^{1 / 2} {( l )}^{5 / 2} ( \frac{ρ}{{E}^{1 / 4}} ) \qquad Equation S6$$

The grouped material properties define the material index (MI). Because the functional and geometric parameters are constrained, minimizing the mass of the beam requires minimizing

$$( MI = \frac{ρ}{{E}^{1 / 2}} ) .$$

Many other material indices have been and can be derived for different scenarios in this same way (see Table S1 below). Material indices can be modified to design for cost (e.g., a cheap, stiff beam) or embodied greenhouse gas (GHG) emissions (e.g., a low emission, stiff beam) by multiplying by specific price ($/kg) or specific embodied CO₂-equivalent emissions (kg CO₂-eq/kg). Any mass normalized parameter (Cₓ) can be optimized this way

$$( e . g . , ( MI = \frac{{C}_{x} ρ}{{E}^{1 / 2}} ) )$$

Section 2. A complete derivation of an MI for minimizing persistence. Function: Short-lived, stiff beam. Objective: Minimize environmental lifetime (t_{L}). Constraints: Deflection (δ), beam length (l₀), loading (F), configuration (C₁). Free variables: Cross-sectional area (A_{c}), material of choice.

Consider, for example, the design of an environmentally short-lived, stiff beam instead of a light, stiff beam. Its functions and constraints are the same, but the objective is different: minimizing the beam's environmental lifetime. In the same way, the design constraints define the beam's mass; they contribute to defining its environmental lifetime.

For practical purposes, Equation 1 (above) is redefined as a function of the instantaneous mass (m), specific surface degradation rate (k_{d}), and the instantaneous surface area to volume ratio

$$( \frac{{A}_{s}}{V} )$$

### (Equation S7).

$$\frac{dm}{dt} = - {mk}_{d} \frac{{A}_{s}}{V} \qquad Equation S7$$

For a beam with a solid square cross-section, its surface area to volume ratio can be calculated using Equation S8.

$$\frac{{A}_{s}}{V} = \frac{2}{l} + \frac{4}{b} \qquad Equation S8$$

The edge and beam lengths reduce in size with degradation and can be parameterized in terms of their initial lengths, b0 and l0, and k_{d} (Equations S9 and S10).

$$l = {l}_{0} - 2 {k}_{d} t \qquad Equation S9$$

$$b = {b}_{0} - 2 {k}_{d} t \qquad Equation S10$$

Thus, combining Equations S7-S10, the degradation rate is a first-order linear ordinary differential equation (Equation S11).

$$\frac{dm}{dt} = - m ( \frac{2 {k}_{d}}{{l}_{0} - 2 {k}_{d} t} + \frac{4 {k}_{d}}{{b}_{0} - 2 {k}_{d} t} ) \qquad Equation S11$$

Integration of Equation S11 and applying the initial condition, m(0)=pb₀²l₀, yields an equation for the remaining mass of the beam during degradation (Equation S12).

$$m ( t ) = {ρ ( {b}_{0} - 2 {k}_{d} t )}^{2} ( {l}_{0} - 2 {k}_{d} t ) \qquad Equation S12$$

Equation S12 can be solved for environmental lifetime, t_{L}, (Equation 2 above, reproduced below for clarity) by applying the condition, m(t_{L})=0 and assuming the beam's length is much greater than the beam's edge length (l₀>b₀).

$${t}_{L} = \frac{{b}_{0}}{2 {K}_{d}} \qquad Equation 2$$

Therefore, maximizing the specific surface degradation rate (kd) and minimizing the beam's edge length minimizes the beam's environmental lifetime. Substituting Equation 3 into Equation 2 and grouping parameters defines the environmental lifetime in terms of the constraints (Equation 4 above, reproduced below for clarity).

$${t}_{L} = {( \frac{12 F}{{C}_{1} δ} )}^{1 / 4} {( \frac{{l}_{0}}{\sqrt[3]{16}} )}^{3 / 4} ( \frac{1}{{k}_{d} {E}^{1 / 4}} ) \qquad Equation 4$$

Thus, grouping the material properties expressed in Equation 4, the MI for environmental lifetime of a beam with a solid square cross-section is

$$( \frac{1}{{k}_{d} {E}^{1 / 4}} ) .$$

Section 3. A complete derivation of Equation 6: The equation for a degrading mass as a function of time can be approximated for simple geometries (films, cylinders, and spheres), where d0 is a characteristic dimension (e.g., the thickness of a film, radius of a cylinder or sphere), and n is a dimensionless ‘shape factor’ (n is 1 for films, 2 for cylinders, and 3 for spheres). This model adjusts the ideal surface area to volume ratio shape (e.g., a film) to fit that of other shapes. It can be a helpful equation for approximating the mass loss behavior of more complex geometries so long as the product retains the same morphology as it degrades.

$$m ( t ) = ρ {{V}_{0} ( 1 - \frac{2 {k}_{d} t}{{d}_{0}} )}^{n} = ρ {{V}_{0} ( 1 - \frac{t}{{t}_{L}} )}^{n} \qquad Equation S13$$

Integration of this approximation for mass as a function of time simplifies the calculation of the cost of plastic pollution.

$$\begin{matrix}{\int }_{t = 0}^{{t}_{L}} m & dt = {\int }_{t = 0}^{{t}_{L}} ρ {{V}_{0} ( 1 - \frac{t}{{t}_{L}} )}^{n} & dt = ρ {V}_{0} ( \frac{{t}_{L}}{n + 1} )\end{matrix} \qquad Equation S14$$

Substituting Equation S14 into Equation 5 yields Equation 6 (above, reproduced below for clarity):

$${C}_{P} = ( {α}_{L} {X}_{P} {f}_{P} ) ( \frac{{m}_{0} {t}_{L}}{n + 1} ) \qquad Equation 6$$

Section 4. A complete derivation of the MI for the environmental lifetime of a disposable coffee cup lid assumed to be a stiff, thin, simply supported disk. Function: Short-lived, stiff, thin, simply supported disk. Objective: Minimize environmental lifetime (t_{L}). Constraints: Deflection (δ), disc radius (r₀), loading (F), configuration (C₁). Free variables: Disk (A_{c}), material of choice. For practical purposes, we redefined Equation 1 as a function of the instantaneous mass (m), k_{d}, and the instantaneous surface area to volume ratio

$$\frac{{A}_{s}}{V}$$

(Equation S7 above, reproduced below for clarity).

$$\frac{d m}{dt} = - m {k}_{d} \frac{{A}_{s}}{V} \qquad Equation S7$$

For a thin disk, its surface area to volume ratio can be calculated using Equation S15, where r is the instantaneous radius of the disk, and h is the instantaneous thickness of the disk.

$$\frac{{A}_{s}}{V} = \frac{2}{r} + \frac{2}{h} \qquad Equation S15$$

Both r and h reduce in size with degradation and can be parameterized in terms of their initial lengths, r₀ and h₀, and k_{d} (Equations S16 and S17):

$$r = {r}_{0} - {k}_{d} t \qquad Equation S16$$

$$h = {h}_{0} - 2 {k}_{d} t \qquad Equation S17$$

Thus, combining Equations S7, S15-S17, the degradation rate is a first-order linear ordinary differential equation (Equation S18):

$$\frac{d m}{dt} = - m {k}_{d} ( \frac{2}{{r}_{0} - {k}_{d} t} + \frac{2}{{h}_{0} - 2 {k}_{d} t} ) \qquad Equation S18$$

Integration of Equation S18 and applying the initial condition, m(0)=m₀=pπr₀²h₀, yields an equation for the remaining mass of the disk during degradation (Equation S19):

$$m ( t ) = {ρ ( {r}_{0} - 2 {k}_{d} t )}^{2} ( {h}_{0} - 2 {k}_{d} t ) \qquad Equation S19$$

Equation S19 can be solved for environmental lifetime, tL, (Equation S20) by applying the condition, m(t_{L})=0 and assuming the disk's radius is much greater than the disk's thickness (r₀>h₀):

$${t}_{L} = \frac{{h}_{0}}{2 {k}_{d}} \qquad Equation S20$$

The mechanical constraints on h₀ are defined by the constraints, no sagging under the lid's weight (F=mg) and is simply supported. The deflection of a simply supported disk is (Equation S21):

$$δ = \frac{3}{4} ( 1 - {v}^{2} ) \frac{Δ {pr}_{0}^{2}}{E {h}_{0}^{3}} \qquad Equation S21$$

Assuming a Poisson ratio (v) of 0.3 and the pressure Δp acting on the disk is its self-weight

$$( \frac{{m}_{0} g}{π {r}_{0}^{2}} ) ,$$

where m₀=ρπr₀²h₀, gives Equation S22:

$${h}_{0} = \sqrt{( 0.6825 ) \frac{ρ g {r}_{0}^{2}}{E δ}} \qquad Equation S22$$

Thus, substituting Equation S22 into Equation S20 yields the relationship for tL (Equation S23):

$${t}_{L} = {( 0.170625 \frac{g}{δ} )}^{1 / 2} ( {r}_{0}^{2} ) {( \frac{ρ}{E {k}_{d}^{2}} )}^{1 / 2} \qquad Equation S23$$

Grouping the parameters shows that the MI is:

$$MI = \frac{ρ}{E {k}_{d}^{2}}$$

TABLE S1
Common material indices for minimizing mass and their
complementary index for minimizing environmental lifetime

| Scenario | Material Index | |
|---|---|---|
| Beams | Stiffness | Strength |
| Light | $\frac{ρ}{{E}^{1 / 2}}$ | $\frac{ρ}{{σ}_{y}^{2 / 3}}$ |
| Short-lived (solid, circular/square) | $\frac{1}{{k}_{d} {E}^{1 / 4}}$ | $\frac{- 1}{{k}_{d} {σ}_{y}^{1 / 3}}$ |
| Ties | Stiffness | Strength |
| Light | ρ/E | $\frac{ρ}{{σ}_{y}}$ |
| Short-lived (solid) | $\frac{1}{{k}_{d} {E}^{1 / 2}}$ | $\frac{1}{{k}_{d} {σ}_{y}^{1 / 2}}$ |

| Columns | Buckling |
|---|---|
| Light | $\frac{ρ}{{E}^{1 / 2}}$ |
| Short-lived (solid) | $\frac{1}{{k}_{d} {E}^{1 / 4}}$ |
| Cylindrical Pressure Vessel | Strength |
| Light | $\frac{ρ}{{σ}_{y}}$ |
| Short-lived | $\frac{1}{{k}_{d} {σ}_{y}}$ |

TABLE S2
Density (g/cm³) of common and commodity plastics

| Plastic | Median | Low | High |
|---|---|---|---|
| PET | 1.35 | 1.30 | 1.40 |
| PA | 1.15 | 1.10 | 1.20 |
| PHA | 1.24 | 1.23 | 1.25 |
| PLA | 1.23 | 1.21 | 1.25 |
| PS | 1.05 | 1.00 | 1.10 |
| PCL | 1.12 | 1.12 | 1.12 |
| PC | 1.15 | 1.10 | 1.20 |
| PBS | 1.25 | 1.24 | 1.26 |
| PBAT | 1.26 | 1.26 | 1.26 |
| PP | 0.90 | 0.89 | 0.91 |
| LDPE | 0.92 | 0.91 | 0.93 |
| HDPE | 0.95 | 0.94 | 0.96 |
| CDA | 1.30 | 1.25 | 1.35 |
| PVC | 1.45 | 1.30 | 1.60 |
| PUR | 1.15 | 1.10 | 1.20 |

TABLE S3
Young's modulus (GPa) of common and commodity plastics

| Plastic | Median | Low | High |
|---|---|---|---|
| PET | 3.45 | 2.8 | 4.1 |
| PA | 2.9 | 2.6 | 3.2 |
| PHA | 2.4 | 0.8 | 4 |
| PLA | 3.64 | 3.45 | 3.83 |
| PS | 1.9 | 1.2 | 2.6 |
| PCL | 0.47 | 0.44 | 0.5 |
| PC | 2.2 | 2.0 | 2.4 |
| PBS | 0.513 | 0.3 | 0.726 |
| PBAT | 0.144 | 0.048 | 0.239 |
| PP | 1.25 | 0.9 | 1.6 |
| LDPE | 0.215 | 0.13 | 0.3 |
| HDPE | 0.76 | 0.62 | 0.9 |
| CDA | 3.25 | 2.4 | 4.1 |
| PVC | 3.1 | 2.1 | 4.1 |
| PUR | 1.7 | 1.3 | 2.1 |

TABLE S4
Price ($USD 2016) of common and commodity plastics

| Plastic | Median | Low | High |
|---|---|---|---|
| PET | 2.2 | 2.1 | 2.3 |
| PA | 4.3 | 4.1 | 4.5 |
| PHA^{a} | 3.71 | 3.30 | 4.12 |
| PLA^{a} | 2.78 | 2.47 | 3.09 |
| PS | 3.15 | 2.8 | 3.5 |
| PCL | 2.78 | 2.47 | 3.09 |
| PC | 4.85 | 4.6 | 5.1 |
| PBS | 3.37 | 3.37 | 3.37 |
| PBAT^{b} | 3.37 | 3.37 | 3.37 |
| PP | 2.25 | 2.1 | 2.4 |
| LDPE | 2.2 | 2.1 | 2.3 |
| HDPE | 2.2 | 2.1 | 2.3 |
| CDA | 4.3 | 4.1 | 4.5 |
| PVC | 2.1 | 2 | 2.2 |
| PUR | 4.35 | 4.1 | 4.6 |

^{a}adjusted from $USD 2013
^{b}adjusted from the price in North America from December 2022

TABLE S5
Embodied greenhouse gas emissions (kg CO₂-eq/kg
plastic) of common and commodity plastics

| Plastic | Median | Low | High |
|---|---|---|---|
| PET | 3.54 | 2.14 | 4.93 |
| PA | 7.78 | 6.41 | 9.15 |
| PHA | 2.25 | −2.38 | 6.87 |
| PLA | 1.95 | −0.73 | 4.63 |
| PS | 4.11 | 2.27 | 5.94 |
| PCL | 1.95 | −0.73 | 4.63 |
| PC | 4.80 | 4.80 | 4.80 |
| PBS | 4.42 | 2.27 | 6.58 |
| PBAT | 1.89 | 0.92 | 2.86 |
| PP | 1.85 | 1.55 | 2.14 |
| LDPE | 3.43 | 1.89 | 4.97 |
| HDPE | 3.43 | 2.10 | 4.76 |
| CDA | 1.57 | −1.03 | 4.17 |
| PVC | 2.29 | 1.89 | 2.69 |
| PUR | 4.63 | 4.08 | 5.18 |

TABLE S6
Embodied water usage (m² crop-eq/kg plastic)
of common and commodity plastics

| Plastic | Median | Low | High |
|---|---|---|---|
| PET | 0.07 | 0.07 | 0.07 |
| PA | 6.86 | 6.86 | 6.86 |
| PHA | 7.43 | 2.29 | 12.57 |
| PLA | 3.79 | 1.21 | 6.43 |
| PS | 0.07 | 0.07 | 0.07 |
| PBS | 3.57 | 3.57 | 3.57 |
| PBAT | 3.50 | 3.50 | 3.50 |
| PP | 0.07 | 0.07 | 0.07 |
| LDPE | 0.07 | 0.07 | 0.07 |
| HDPE | 0.07 | 0.07 | 0.07 |
| CDA | 1.07 | 0.21 | 1.86 |
| PVC | 0.43 | 0.43 | 0.43 |
| PUR | 2.57 | 2.57 | 2.57 |

TABLE S7
Table S7. Marine/seawater specific surface degradation
rate (μm/yr) of common and commodity plastics

| Plastic | Scale of Experiment | SSDR | Details on Plastics |
|---|---|---|---|
| CDA | Field/Mesocosm | 43.8 | Supplied by Eastman Chemical Company |
| CDA | Field/Mesocosm | 43.7 | Supplied by Eastman Chemical Company |
| HDPE | Field/Mesocosm | 12.0 | None |
| HDPE | Field/Mesocosm | 11.4 | None |
| LDPE | Field/Mesocosm | 14.3 | None |
| LDPE | Field/Mesocosm | 38.0 | None |
| LDPE | Bottle | 6.0 | ET31-FM-000150, Goodfellow |
| LDPE | Bottle | 8.4 | ET31-SH-000110, Goodfellow |
| LDPE | Bottle | 6.3 | ET31-SH-000110, Goodfellow |
| PA | Bottle | 129.0 | Synthesized |
| PBAT | Bottle | 1.5 | Ecoflex F Blend A1200, BASF |
| PBAT | Field/Mesocosm | 6.7 | Ecoflex F Blend C 1200, BASF |
| PBAT | Bottle | 4.3 | Ecoflex F Blend C 1200, BASF |
| PBAT | Bottle | 9.6 | Ecoflex F Blend C1200, BASF |
| PBS | Bottle | 6.5 | Supplied by Showa High Polymer |
| PBS | Bottle | 13.0 | Supplied by Showa High Polymer |
| PBS | Bottle | 13.0 | Supplied by Showa High Polymer |
| PBS | Bottle | 13.0 | Supplied by Showa High Polymer |
| PBS | Bottle | 6.4 | Bionolle 1020MD |
| PC | Field/Mesocosm | 5.2 | Lexan, GE Plastic |
| PC | Field/Mesocosm | 5.6 | Lexan, GE Plastic |
| PCL | Bottle | 1.5 | CAPA 6800, Perstorp |
| PCL | Field/Mesocosm | 260.7 | CAPA 6800, Perstorp |
| PCL | Bottle | 365.0 | Synthesized |
| PCL | Bottle | 514.9 | Synthesized |
| PCL | Bottle | 436.7 | Synthesized |
| PCL | Bottle | 651.8 | Synthesized |
| PCL | Field/Mesocosm | 32.0 | Synthesized |
| PET | Bottle | 0.2 | PET RT32, Trevira |
| PET | Field/Mesocosm | 39.7 | None |
| PET | Bottle | 10.1 | ES30-SH-000110, Goodfellow |
| PHAs | Bottle | 12.9 | Polyhydroxybutyrate, Goodfellow |
| PHAs | Field/Mesocosm | 57.9 | ENMAT Y1000P, Tianan Biological |
| | | | Materials |
| PHAs | Field/Mesocosm | 114 | Fermentation; ρ = 1.25 g/cm3 |
| PHAs | Field/Mesocosm | 113 | Fermentation; ρ = 1.25 g/cm3 |
| PHAs | Field/Mesocosm | 199 | Fermentation; ρ = 1.25 g/cm3 |
| PHAs | Field/Mesocosm | 213 | Fermentation; ρ = 1.25 g/cm3 |
| PHAs | Field/Mesocosm | 312 | Fermentation; ρ = 1.25 g/cm3; E = 1100 MPa |
| PHAs | Field/Mesocosm | 152 | Fermentation; ρ = 1.25 g/cm3 |
| PHAs | Field/Mesocosm | 191 | Fermentation; ρ = 1.231 g/cm3 |
| PHAs | Field/Mesocosm | 139 | Fermentation; ρ = 1.231 g/cm3 |
| PHAs | Field/Mesocosm | 139 | Fermentation; ρ = 1.231 g/cm3 |
| PHAs | Field/Mesocosm | 137 | Fermentation; ρ = 1.232 g/cm3 |
| PHAs | Field/Mesocosm | 24.9 | BIOPOL, Zeneca Bioproducts |
| PHAs | Bottle | 91.3 | Fermentation |
| PHAs | Bottle | 176.0 | Fermentation |
| PHAs | Bottle | 267.2 | Fermentation |
| PHAs | Bottle | 117.3 | Fermentation |
| PHAs | Field/Mesocosm | 23.7 | Mirel P5001; Metabolix |
| PHAs | Field/Mesocosm | 37.2 | Mirel P5001; Metabolix |
| PHAs | Field/Mesocosm | 285.7 | Mirel P5001; Metabolix |
| PHAs | Field/Mesocosm | 43.5 | Mirel P5001; Metabolix |
| PHAs | Field/Mesocosm | 21.1 | Mirel P5001; Metabolix |
| PHAs | Field/Mesocosm | 12.4 | Mirel P5001; Metabolix |
| PHAs | Field/Mesocosm | 303.0 | Sigma-Aldrich |
| PHAs | Field/Mesocosm | 500.3 | Synthesized |
| PHAs | Field/Mesocosm | 189.4 | Synthesized; E = 400 MPa |
| PHAs | Field/Mesocosm | 127.6 | Synthesized |
| PHAs | Field/Mesocosm | 179.4 | Synthesized; E = 180 MPa |
| PHAs | Field/Mesocosm | 58.1 | PHB Industrial S/A |
| PHAs | Field/Mesocosm | 52.2 | PHB Industrial S/A |
| PHAs | Field/Mesocosm | 43.2 | RIKEN Institute |
| PHAs | Bottle | 521.4 | ICI Biological Products |
| PHAs | Bottle | 1560.4 | Metabolix; E = 700-900 MPa |
| PHAs | Bottle | 104.0 | Metabolix; E = 700-900 MPa |
| PHAs | Bottle | 173.4 | Metabolix; E = 900-1500 MPa |
| PHAs | Bottle | 660.2 | Metabolix; E = 900-1500 MPa |
| PHAs | Field/Mesocosm | 11.5 | Sigma-Aldrich |
| PHAs | Field/Mesocosm | 57.9 | Fermentation |
| PHAs | Field/Mesocosm | 318.7 | Fermentation |
| PLA | Bottle | 0.8 | Resomer L 210 S, Evonik |
| PLA | Field/Mesocosm | 1.78 | Ingeo 4060D, Nature Works |
| PLA | Bottle | 0.26 | Ingeo 4060D, Nature Works |
| PLA | Bottle | 2.9 | Ingeo 7001D, Nature Works; E = 3487 MPa |
| PLA | Bottle | 7.2 | Ingeo 7001D, Nature Works; E = 3487 MPa |
| PLA | Bottle | 1.5 | None |
| PLA | Bottle | 10.6 | Ingeo 10361D, Nature Works |
| PLA | Field/Mesocosm | 1.3 | Lacty 5000, Shimadzu |
| PLA | Field/Mesocosm | 0.1 | Lacty 5000, Shimadzu |
| PP | Field/Mesocosm | 4.9 | None |
| PP | Bottle | 0.2 | PP108MF, Sabic; E = 610 MPa |
| PP | Field/Mesocosm | 7.6 | None |
| PP | Bottle | 18.3 | PP30-SH-000100, Goodfellow |
| PS | Bottle | 8.0 | None |
| PS | Bottle | 7.3 | None |
| PS | Bottle | 10.0 | ST31-SH-000120, Goodfellow |
| PU | Field/Mesocosm | 63.8 | None |
| PU | Field/Mesocosm | 193.0 | Synthesized |
| PU | Field/Mesocosm | 42.0 | Synthesized |

TABLE S8
Summary of marine/seawater specific surface degradation
rate (k_{d}) (μm/yr) of common and commodity plastics

| Plastic | Mean | High | Low |
|---|---|---|---|
| PET | 16.7 | 39.7 | 0.2 |
| PA | 201.5 | 439.1 | 36.4 |
| PHAs | 194.9 | 1560.4 | 11.5 |
| PLA | 2.9 | 10.6 | 0.1 |
| PS | 8.4 | 10.0 | 7.3 |
| PCL | 323.2 | 651.8 | 1.5 |
| PC | 5.4 | 5.6 | 5.2 |
| PBS | 10.4 | 13.0 | 6.4 |
| PBAT | 5.5 | 9.6 | 1.5 |
| PP | 7.8 | 18.3 | 0.2 |
| LDPE | 14.6 | 38.0 | 6.0 |
| HDPE | 11.7 | 12.0 | 11.4 |
| CDA | 52.1 | 59.0 | 45.2 |
| PU | 99.6 | 193.0 | 42.0 |

TABLE S9
Calculated MIs of common and commodity plastics for a solid beam with a square cross-
section

| | M₁ (cost) | | M₂ (GHG) | | M₁ (lifetime) | |
|---|---|---|---|---|---|---|
| | $\frac{{C}_{m} ρ}{{E}^{1 / 2}}$ | $[ \frac{\$ USD}{{m}^{3} \cdot MP {a}^{1 / 2}} ]$ | $\frac{{C}_{GHG} ρ}{{E}^{1 / 2}}$ | $[ \frac{kg {CO}_{2} - e q}{{m}^{3} \cdot MP {a}^{1 / 2}} ]$ | $\frac{1}{{k}_{d} {E}^{1 / 4}}$ | $[ \frac{y r}{mm \cdot MP {a}^{1 / 4}} ]$ |
| Plastic | Low | High | Low | High | Low | High |
| PET | 42.64 | 60.85 | 43.46 | 130.42 | 3.15 | 687.35 |
| PA | 88.45 | 105.90 | 138.25 | 215.45 | 0.32 | 3.85 |
| PHA | 143.51 | 182.08 | −103.51 | 303.76 | 0.12 | 16.35 |
| PLA | 50.88 | 65.76 | −15.09 | 98.61 | 12.31 | 1304.80 |
| PS | 80.83 | 111.14 | 65.46 | 188.74 | 16.99 | 23.27 |
| PCL | 131.88 | 164.99 | −39.11 | 247.42 | 0.33 | 145.56 |
| PC | 113.15 | 136.85 | 118.06 | 128.80 | 26.70 | 28.76 |
| PBS | 241.26 | 245.15 | 162.34 | 478.49 | 18.48 | 37.54 |
| PBAT | 612.89 | 612.89 | 166.50 | 519.98 | 39.57 | 253.28 |
| PP | 62.30 | 72.80 | 45.96 | 64.94 | 9.98 | 912.87 |
| LDPE | 167.61 | 187.60 | 150.63 | 405.53 | 7.79 | 49.36 |
| HDPE | 79.28 | 88.68 | 79.22 | 183.54 | 16.70 | 17.58 |
| CDA | 104.61 | 124.01 | −26.23 | 114.88 | 2.42 | 3.16 |
| PUR | 125.08 | 120.46 | 124.61 | 135.73 | 0.86 | 3.52 |

TABLE S10
Table S10. Exchange constants for environmental impact|

| Value or Cost | Performance | Exchange Constant |
|---|---|---|
| Amount of material | Mass (kg) | Material cost ($/kg) |
| Product lifecycle CO₂ emissions | GHG emissions (kg CO₂) | Carbon tax ($/kg CO₂) |
| Product lifecycle CO₂ emissions | GHG emissions (kg CO₂) | Social cost ($/kg CO₂) |
| Energy usage in production | Embodied energy (MJ) | Energy cost/tax ($/MJ) |
| Energy savings in transportation | Energy use (MJ) | Fuel cost ($/MJ) |

TABLE S11
Table S11. Measured properties of on-
the-market disposable coffee cup lids

| Plastic | Lid Thickness (mm) | Lid Mass (mg) | Density (kg/m³) |
|---|---|---|---|
| PP | 0.428 | 3870.8 | 931 |
| PS | 0.305 | 3635.3 | 1035 |
| PLA | 0.262 | 2981.8 | 1383 |

TABLE S12
Table S12. Calculated properties of hypothetical
disposable coffee cup lids

| Plastic | Lid Thickness (mm) | Lid Mass (mg) |
|---|---|---|
| CDA | 0.264 | 3118.0 |
| PHA | 0.305 | 3347.0 |
| PBS | 0.591 | 4948.7 |
| PBAT | 0.966 | 7056.3 |

TABLE S13
Table S13. Value function results in $USD
2016 for disposable coffee cup lids

| | | | | | Cost of Plastic | |
|---|---|---|---|---|---|---|
| | Cost of Material | | Social Cost of CO₂ | | Pollution | |
| Plastic | Low | High | Low | High | Low | High |
| PP | $8.13 | $9.29 | $1.04 | $1.43 | $2.41 | $220.51 |
| PS | $10.18 | $12.72 | $1.43 | $3.74 | $2.95 | $4.04 |
| PLA | $7.37 | $9.21 | −$0.38 | $2.39 | $1.96 | $207.96 |
| PBS | $16.68 | $16.68 | $1.94 | $5.63 | $5.99 | $12.16 |
| PBAT | $23.78 | $23.78 | $1.12 | $3.49 | $18.91 | $121.02 |
| CDA | $12.78 | $14.03 | −$0.55 | $2.25 | $0.50 | $0.50 |
| PHA | $11.04 | $13.79 | −$1.38 | $3.98 | $0.02 | $2.36 |

Supporting information for FIGS. 3 and 4 is shown in Table S14:

Supplementary TABLE S14
Material indices (MIs) for sheets^{a}

| | Stiffness-limited | |
|---|---|---|
| MI | design | Strength-limited design |
| Material efficiency | $\frac{ρ}{{E}^{1 / 3}}$ | $\frac{ρ}{{σ}_{y}^{1 / 2}}$ |
| Material cost efficiency | $\frac{{C}_{\$} ρ}{{E}^{1 / 3}}$ | $\frac{{C}_{\$} ρ}{{σ}_{y}^{1 / 2}}$ |
| Minimal GHG emissions | $\frac{{C}_{GHG} ρ}{{E}^{1 / 3}}$ | $\frac{{C}_{GHG} ρ}{{σ}_{y}^{1 / 2}}$ |
| Minimal water usage | $\frac{{C}_{w a t e r} ρ}{{E}^{1 / 3}}$ | $\frac{{C}_{w a t e r} ρ}{{σ}_{y}^{1 / 2}}$ |
| Minimal energy usage | $\frac{{C}_{energy} ρ}{{E}^{1 / 3}}$ | $\frac{{C}_{energy} ρ}{{σ}_{y}^{1 / 2}}$ |
| Minimal environmental lifetime | $\frac{1}{{k}_{d} {E}^{1 / 3}}$ | $\frac{1}{{k}_{d} {σ}_{y}^{1 / 2}}$ |

^{a}ρ = density; E = Young's modulus; σ_{y} = yield strength; C_{$} = specific price; C_{GHG} = specific embodied greenhouse gas emissions (GHG); C_{water} = specific embodied water usage; C_{energy} = specific embodied energy usage; k_{d} = specific surface degradation rate

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is to be understood that the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions. Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on, or executable by, a programmable computer including any combination of any number of the following: a processor, a storage medium readable and/or writable by the processor (including, for example, volatile and non-volatile memory and/or storage elements), an input device, and an output device. A processor is also referred to herein as a processing resource. The input device and/or the output device form a user interface in some embodiments. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention automatically compare multiple assigned factors including geometry and material property, and identify a specific surface degradation rate for an assigned object, automatically determine environmental lifetime for that object, automatically update data in an electronic memory representing such information, and automatically and iteratively repeat such analysis with at least one changed assigned value until at least one of cost and/or environmental lifetime converge. Such features can only be performed by computers and other machines and cannot be performed manually or mentally by humans.

Any claims herein which affirmatively require a computer, a processor, a controller, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a controller, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays).

A computer can generally also receive (read) programs and data from, and write (store) programs and data to, a non-transitory computer-readable storage medium such as an internal disk (not shown) or a removable disk or flash memory. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium or other type of user interface. Any data disclosed herein may be implemented, for example, in one or more data structures tangibly stored on a non-transitory computer-readable medium. Embodiments of the invention may store such data in such data structure(s) and read such data from such data structure(s).

It is the intention, therefore, to be limited only as indicated by the scope of the claims appended hereto. Other embodiments will occur to those skilled in the art after reviewing the present disclosure and are within the following claims.

What is claimed is:

1. A system to optimize composition and/or geometry of an object to decrease its environmental lifetime, the system comprising:
a database module including specific surface degradation rate information in a non-transitory storage medium;
an environmental lifetime module that (1) receives geometry information and material property information for the object including an assigned material, a density, and a specific surface degradation rate for that material and (2) determines an environmental lifetime for the object based on (a) the geometry of the object, (b) the assigned material, (c) the density, and (d) the specific surface degradation rate; and
a design objectives trade-off module that (1) receives geometry and environmental lifetime for the object plus at least density and material price information for the assigned material and (2) generates a report detailing performance of the geometry for the object using the assigned material with respect to at least the cost and environmental lifetime information to enable optimization of at least one of cost and/or environmental lifetime for the object.

2. The system of claim 1 wherein report includes a design recommendation to optimize at least one of cost and/or environmental lifetime for the object.

3. The system of claim 1 wherein report includes a human-viewable plot of values.

4. The system of claim 1 wherein the database module determines a specific surface degradation rate (k_{d}) for at least one material.

5. The system of claim 1 wherein the geometry information received by the environmental lifetime module includes at least volume and surface area of the object, and the environmental lifetime is determined based also on the mass of the object.

6. A system to optimize composition and/or geometry of an object to decrease its environmental lifetime, the system comprising:
at least one computer processor;
at least one database module operatively connected to the processor and including specific surface degradation rate information in a non-transitory storage medium;
at least one computer-readable, non-transitory instruction medium operatively connected to the processor and having stored thereon instructions that when executed by the processor cause the processor to optimize selection of material for and/or geometry of an object with decreased environmental lifetime, the instructions including:
(1) obtaining and storing a specific surface degradation rate information in the non-transitory storage medium for each assigned material;
(2) receiving assigned geometry information and assigned material property information for the object including an assigned material, an assigned density and a specific surface degradation rate for that assigned material;
(3) determining an environmental lifetime for the object based on (a) the assigned geometry of the object, (b) the assigned material, (c) the assigned density, and (d) the specific surface degradation rate;
(4) iteratively repeating steps (2) to (3) with at least one changed assigned value until environmental lifetime converges to value less than or equal to a pre-selected convergence criteria;
(5) receiving assigned geometry and environmental lifetime for the object plus at least assigned density and material price information for the assigned material; and
(6) generating a report detailing performance of the geometry for the object using the assigned material with respect to at least the cost and environmental lifetime information.

7. The system of claim 6 wherein the report is provided to an output device to enable the report to be viewed by a user of the system.

8. The system of claim 6 wherein receiving assigned geometry in step (2) includes at least volume and surface area of the object, and the environmental lifetime is determined based also on the mass of the object.

9. A method to optimize selection of material for and/or geometry of an object with decreased environmental lifetime, the method comprising:
obtaining and storing a specific surface degradation rate information in a non-transitory storage medium;
receiving geometry information and material property information for the object including an assigned material, an assigned density and a specific surface degradation rate for that material;
determining an environmental lifetime for the object based on (a) the geometry of the object, (b) the assigned material, (c) the density, and (d) the specific surface degradation rate;
receiving geometry and environmental lifetime for the object plus at least density and material price information for the assigned material;
generating a report detailing performance of the geometry for the object using the assigned material with respect to at least the cost and environmental lifetime information; and
optimizing at least one of cost and/or environmental lifetime for the object.

10. The method of claim 9 wherein optimizing includes iteratively repeating the step of determining an environmental lifetime with at least one changed assigned value until environmental lifetime converges to value less than or equal to a pre-selected convergence criteria.

11. The method of claim 9 wherein optimizing includes providing at least one design recommendation to optimize at least one of cost and/or environmental lifetime for the object.

12. The method of claim 9 wherein generating the report includes producing a human-viewable plot of values.

13. The method of claim 9 wherein the object is selected to be made of a polymeric material.

14. The method of claim 9 wherein obtaining includes determining a specific surface degradation rate (k_{d}) for at least one assigned material.

15. The method of claim 14 wherein determining includes evaluating degradation of test samples of the object over time.

16. The method of claim 9 wherein receiving the geometry information includes at least volume and surface area of the object, and the environmental lifetime is determined based also on the mass of the object.

17. The method of claim 9 wherein optimizing includes evaluating performance of the object for at least one of mechanical, thermal, electrical, magnetic, flow, and/or processing performance.
